(19) United States
(12) Patent Application Publication
(10) Pub. No.: US 2013/0218801 A1
(43) Pub. Date: Aug. 22, 2013

(54) METHOD AND SYSTEM FOR GRANT MANAGEMENT AND FUNDING

(71) Applicant: OPENONWARD, LLC, (US)

(72) Inventor: Carlo RAGO, Baltimore, MD (US)

(73) Assignee: OPENONWARD, LLC, Baltimore, MD (US)

(21) Appl. No.: 13/757,522

(22) Filed: Feb. 1, 2013

Related U.S. Application Data
(60) Provisional application No. 61/593,648, filed on Feb. 1, 2012.

(51) Int. Cl. G06Q 30/02; G06F 17/22

(52) U.S. Cl. CPC G06Q 30/0279; G06F 17/2235
USPC 705/342; 715/205

(57) ABSTRACT

An apparatus, method, and system for receiving an electronic submission of at least one grant proposal, determining whether to publish at least a portion of the grant proposal to a publicly-accessible space based on a plurality of indicators, and publishing at least the portion of the grant proposal to the publicly-accessible space if a first indicator and a second indicator of the plurality of indicators are in an authorized publication state.

### CLAIM OF PRIORITY UNDER 35 U.S.C. §119

This application claims the benefit of and priority to U.S. Provisional Patent Application No. 61/593,648, titled “Method and System for Data Management and Funding,” filed Feb. 2, 2012, the disclosure of which is hereby incorporated in its entirety by reference herein.

### BACKGROUND

1. Field

Aspects of the present invention generally relate to data management systems, and more particularly to methods and systems for managing scientific research grants and funding.

2. Introduction

Biomedical research is funded through private foundations that were formed to address specific biomedical problems (e.g., Duchenne Muscular Dystrophy (DMD)). To receive grant funding through foundations typically requires a scientist to reach out to multiple foundations one at a time and submit proposals through their independent systems. For example, there are approximately sixty foundations funding DMD research throughout the world. So for a scientist to reach all sixty of them is a slow and tedious process because the scientist will have to submit the proposal sixty times, and the proposal requirements of each foundation are usually different. As a result, the ensuing funding odyssey consumes valuable time and money.

Foundations often delegate the project proposal vetting process to larger organizations presumed to have better access to the resources required for effective appropriation of funds. However, foundations tasked with vetting have difficulty serving a diverse constituency. Furthermore, foundations are often unaware of what others in their community are funding. The defects of the current system are underscored by the fact that the funding process can take longer than the scientific process. These artificial inefficiencies are particularly savage for patients with degenerative diseases where years, months, and days matter.

Unitary funding systems are seemingly efficient, but centralized control of the knowledgebase and decision-making process may ultimately serve to subvert the collective mission of the community by disenfranchising the member foundations.

Therefore, there exists an unmet need in the art for a system and method for federating scientists, foundations, and the public on a single platform that facilitates the grant proposal submission process, grant proposal review, grant proposal tracking, grant management, grant funding, reporting, and inter-foundation collaboration.

### SUMMARY

According to an aspect of the present invention, a method may include receiving an electronic submission of at least one grant proposal, determining whether to publish at least a portion of the grant proposal to a publicly-accessible space based on a plurality of indicators, and publishing at least the portion of the grant proposal to the publicly-accessible space if a first indicator and a second indicator of the plurality of indicators are in an authorized publication state.

According to another aspect of the present invention, an apparatus may include a proposal module configured to receive an electronic submission of at least one grant proposal, and a public module configured to determine whether to publish at least a portion of the grant proposal to a publicly-accessible space based on a plurality of indicators, and publish at least the portion of the grant proposal to the publicly-accessible space if a first indicator and a second indicator of the plurality of indicators are in an authorized publication state.

According to yet another aspect of the present invention, a system may include means for receiving an electronic submission of at least one grant proposal, means for determining whether to publish at least a portion of the grant proposal to a publicly-accessible space based on a plurality of indicators, and means for publishing at least the portion of the grant proposal to the publicly-accessible space if a first indicator and a second indicator of the plurality of indicators are in an authorized publication state.

According to yet another aspect of the present invention, a computer-readable medium may include code for receiving an electronic submission of at least one grant proposal, code for determining whether to publish at least a portion of the grant proposal to a publicly-accessible space based on a plurality of indicators, and code for publishing at least the portion of the grant proposal to the publicly-accessible space if a first indicator and a second indicator of the plurality of indicators are in an authorized publication state.

According to yet another aspect of the present invention, a method may include receiving a content entry in a content space, receiving a reference link associated with the content entry in the content space, the reference link configured to link out to a third party website with affiliation to the content entry, and generating in the content space a content entry listing having embedded therein the reference link that is configured to link out to the third party website.

According to yet another aspect of the present invention, an apparatus may include a wiki module configured to receive a content entry in a content space, receive a reference link associated with the content entry in the content space, the reference link configured to link out to a third party website with affiliation to the content entry, and generate in the content space a content entry listing having embedded therein the reference link that is configured to link out to the third party website.

According to yet another aspect of the present invention, a system may include means for receiving a content entry in a content space, means for receiving a reference link associated with the content entry in the content space, the reference link configured to link out to a third party website with affiliation to the content entry, and means for generating in the content space a content entry listing having embedded therein the reference link that is configured to link out to the third party website.

According to yet another aspect of the present invention, a computer-readable medium may include code for receiving a content entry in a content space, code for receiving a reference link associated with the content entry in the content space, the reference link configured to link out to a third party website with affiliation to the content entry, and code for generating in the content space a content entry listing having embedded therein the reference link that is configured to link out to the third party website.

It is understood that other aspects of the invention will become readily apparent to those skilled in the art from the following detailed description, wherein various aspects of the present invention are shown and described by way of illustration only. As will be understood, the present invention is capable of other and different variations and its several details are capable of modification in various other respects, all without departing from the scope of the invention. Accordingly, the drawings and detailed description are to be regarded as illustrative in nature and not as restrictive.

### BRIEF DESCRIPTION OF THE DRAWINGS

These and other sample aspects of the disclosure will be described in the detailed description and the appended claims that follow, and in the accompanying drawings, wherein:

FIG. 1 is an example block diagram illustrating a simplified system for federating authors and reviewers via a portal, in accordance with aspects of the present invention;

FIG. 2 is an example block diagram illustrating a system for registering authors and reviewers via the portal, in accordance with aspects of the present invention;

FIG. 3 is an example block diagram illustrating a system for managing a proposal access permission structure between authors and reviewers via a dashboard, in accordance with aspects of the present invention;

FIG. 4 illustrates an example flow diagram of a method for accessing a proposal, in accordance with aspects of the present invention;

FIG. 5 illustrates an example flow diagram of a method for pledging funds to and funding a proposal, in accordance with aspects of the present invention;

FIG. 6 illustrates an example flow diagram of a method for publishing a proposal, in accordance with aspects of the present invention.

FIG. 7 illustrates an example flow diagram of a method displaying therapeutic information in a web-based environment, in accordance with aspects of the present invention.

FIGS. 8A-8D illustrate example screen shots of a registration process in accordance with aspects of the present invention;

FIGS. 9A-9F illustrate example screen shots of a proposal submission process in accordance with aspects of the present invention;

FIG. 10 illustrates an example screen shot of a dashboard space in accordance with aspects of the present invention;

FIGS. 11A-11H illustrate example screen shots of a proposal space in accordance with aspects of the present invention;

FIGS. 12A-12F illustrate example screen shots of a wiki module in accordance with aspects of the present invention;

FIG. 13 depicts a computer system for implementing various aspects of the present invention; and

FIG. 14 is a block diagram of various example system components, in accordance with aspects of the present invention.

In accordance with common practice, the various features illustrated in the drawings may be simplified for clarity. Thus, the drawings may not depict all of the components of a given apparatus or method. In addition, like reference numerals may be used to denote like features throughout the specification and figures.

### DETAILED DESCRIPTION

Various aspects of the present invention are described below. It should be apparent that the teachings herein may be embodied in a wide variety of forms and that any specific structure, function, or both being disclosed herein may be merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality, in addition to or other than one or more of the aspects set forth herein. An aspect may comprise one or more elements of a claim.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem.

Various aspects of the present invention solve the above-identified needs, as well as others, via devices, methods, and systems capable of federating scientists and foundations on a single platform that facilitates the grant proposal submission process, grant proposal tracking, funding, reporting, management and inter-foundation collaboration.

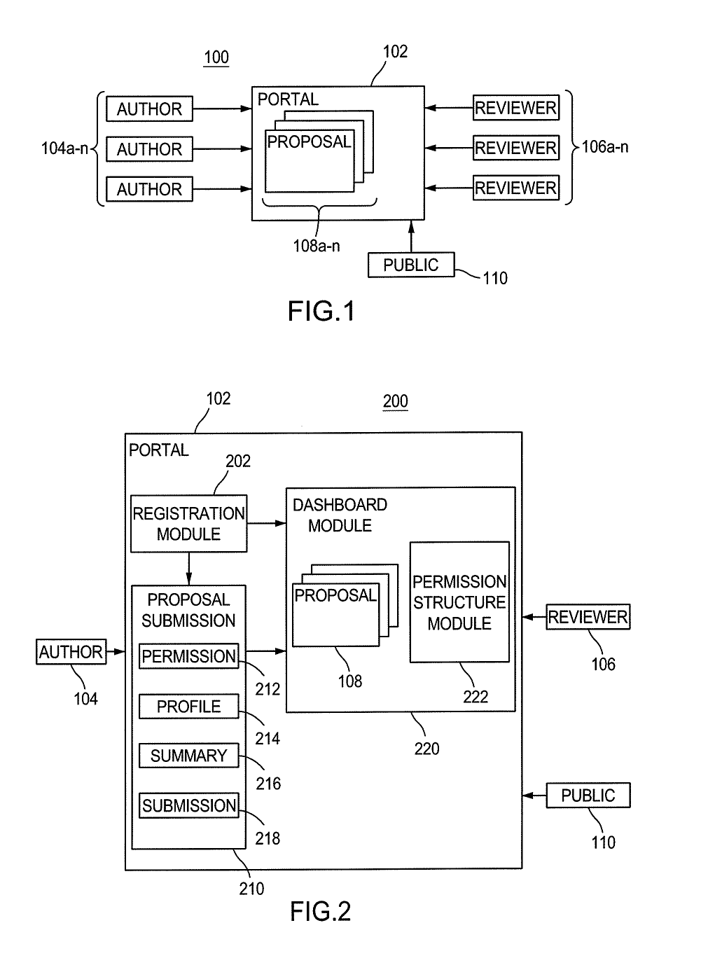

FIG. 1 is an example block diagram illustrating a system 100 for federating authors, reviewers, and the public via a portal. The system may include a plurality of user types, such as authors 104a-n, reviewers 106a-n, and public 110 that may interface with portal 102 through one or more access terminals in communication with the portal 102.

Authors 104a-n are individuals that may submit proposals 108a-n and reviewers 106a-n are individuals who review and fund the submitted proposals 108a-n. The public 110 are individuals who have limited access to the portal, but who may fund the submitted proposals 108a-n, once the proposals 108a-n have been released for funding into the public domain. Via the portal 102, the authors 104a-n may, for example, request funds for their proposals as well as document any work (e.g., research results, publications, etc.) related to their proposals. The authors 104a-n may be scientists, principal investigators, or any individual authorized access to the portal 102. On the other side of the portal 102 are the individuals who review the proposals, typically foundations otherwise referred to herein as reviewers.

Reviewers 106a-n may be individuals who are members of foundations or any individual who is required to participate in the grant proposal review process to successfully execute, e.g., a biomedical research funding mission. It should be noted that the distinction between user types (i.e., authors 104a-n and reviewers 106a-n) is made for clarification purposes only and is not a limitation. For example, an author may qualify as a reviewer, and a reviewer may qualify as an author.

The portal 102 is configured to function as a hub for grant proposal submission, management, review, and funding, as well as for facilitating communication and collaboration among its users.

FIG. 2 is an example block diagram illustrating a system 200 for registering authors and reviewers via the portal 102. In order to access dashboard 220 where author 104 and reviewer 106 may submit and review proposals, the author 104 and reviewer 106 may be required to first register with the dashboard 220.

For the author 104, registration commences when the author 104 triggers a registration event when interfacing with registration module 202 of the portal 102. For example, the registration event may be triggered by the author 104 clicking an “author” registration hypertext link on an access terminal that is in communication with the portal 102.

Once the registration event is triggered, the registration module 202 may prompt the author 104 to proceed through several registration steps. For example, the registration module 202 may first prompt the author 104 to review a legal overview that informs the author 104 of several documents the author 104 will have to agree to complete the registration process. For example, these documents may be a terms and conditions, a general confidential disclosure agreement (CDA), and a proposal related CDA. The registration module 202 may then receive an acknowledgement from the author 104 regarding the legal overview and may then proceed to display a form requesting the author 104 to provide profile information. For example, the form may include text fields where the author 104 may provide the author's name, address, work history, and other information similar to that typically included in a resume or a curriculum vitae.

When the registration module 202 detects that the author 104 has provided information in all of the required text fields and submitted the profile information form, the registration module 202 may progress to the next registration step. For the next registration step, the registration module 202 may display to the author 104 a terms of use agreement with an option to accept or decline. If the registration module 202 detects a selection indicating acceptance of the terms of use agreement, the registration module may progress to the next registration step; otherwise, if the registration module 202 detects a selection indicating a refusal, the registration module 202 may redirect the user 104 out of the registration process.

During the next registration step, the registration module 202 may prompt the author 104 to execute a general CDA. The general CDA may protect any proprietary methods or systems implemented within the system 100 and also broadly cover any confidential information that either the users may be exposed to while using the system 100. The general CDA may also designate all grant proposal related information submitted to the system 100 as confidential, thus classifying any information in a grant proposal as de facto confidential. In order to execute the general CDA, the author 104 may be required to enter a digital signature by, for example, typing their name and title in a text field and selecting an acceptance indicator. Once the registration module 202 detects the submission of an executed general CDA, the registration module 202 may generate a document in a portable file format (e.g., Portable Document Format (PDF)) that will include the digital signature. The registration module 202 may then store the document in a profile of the author 104 such that author 104 and other registered members of the dashboard 220 may be able to view and confirm that the author 104 has executed the general CDA document.

After execution of the general CDA, the registration module 202 may transmit an access request including at least the profile information of the submitted registration information to an administration module (not shown). The administration module may analyze the profile information submitted by the author 104, and may determine, based on the profile information, whether to provide the author 104 with access to dashboard 220. It should be noted that the administration module may include an algorithm for verifying the legitimacy of the profile information either automatically or with assistance from a user. Once the administration module confirms the legitimacy of the profile information, it may transmit a command to the registration module 202 to grant access to the author 104. Once the registration module 202 receives the command, it may generate and provide the author with unique access credentials to access the dashboard, such as a username and password.

The reviewer 106 may register via the registration module 202 to gain access to the dashboard 220 in much the same way as the author 104. Some differences, for example, may relate to the commencement of registration and the profile information requirement for the reviewer 106. For example, the reviewer 106 may trigger the registration event by clicking a “reviewer” registration hyperlink on an access terminal that is in communication with the portal 102. Also, the required profile form to be submitted by the reviewer 106 may include additional text fields, such as those for inputting a name and address of the foundation represented by the reviewer 106. Based on the foundation information provided in the profile form, the registration module 202 or the administration module may create a unique access account for the foundation, including a username and password.

After the author 104 receives the username and password, the author 104 may use the login information to access the dashboard, as well as create and submit a proposal.

The author 104 may commence submission of a proposal by triggering a submission process, which may be triggered by the author 104 clicking on an “add a proposal” link on a navigation bar in the dashboard 220, for example. The proposal submission process may be controlled by a proposal submission module 210.

When the author 104 triggers the proposal submission process, the proposal submission module 210 may detect the trigger and display to the author 104 a plurality of tabs, each of which serves a specific function in the proposal submission process. The proposal submission tabs may include a permission tab 212, a profile tab 214, a summary tab 216, and a submission tab 218.

The permission tab 212 may provide to the author 104 a list of every prospective reviewer, e.g., every individual that is associated with a foundation, such as the foundation head, legal staff, scientific advisors, etc., that is registered with the dashboard 220. Each reviewer entry may show a photograph of the reviewer, the reviewer's education, specialization and country of origin, for example, among other relevant information. For example, the permission tab 212 may provide a link out to each reviewer's profile so that the author 104 may determine if an individual reviewer has a conflict of interest or may be a competitor. The permission tab 212 may also identify the reviewers by foundation or disease type, for example, as well as by what the reviewer's role is in the respective foundation. Based on this information, the author 104 may be able to categorize and sort the reviewers, and have the ability to indicate those reviewers that should be granted access to the proposal and those reviewers that should be denied access to the proposal. Once the author 104 makes any desired reviewer access designations, the author 104 may proceed to the next tab, which may be the profile tab 214.

The profile tab 214 allows the author 104 to further refine and update the author's profile by inputting additional information in the provided text fields, such as further technical capabilities or expertise. The author 104 may choose to update the profile or proceed to the next tab, which may be the summary tab 216.

The summary tab 216 may include text fields and other input fields (e.g., radio buttons) where the author 104 may provide basic information that summarizes the proposal. For example, the summary tab 216 may include text fields for information such as a title of the proposal, categories related to the proposal, intended start and completion dates of the project being undertaken under the proposal, amount requested, suggested mechanism of action, target population tags, and abstract. One or more of the text fields may also inquire whether the author 104 is willing to acknowledge foundations in publications related to the proposal.

The fields for inputting the start and the completion dates of the proposed project may be configured to generate a calendar for inputting the dates. Moreover, the calendar may be integrated with a project management system, such as a Gantt chart, which may be used to track any and all dates related to the project proposal. The Gantt chart may be integrated with a calendar and timeline that can be made available to authors or reviewers that have been granted access to the proposal contents.

The information provided by the author 104 in the summary tab 216 may be used to associate category tags (e.g., pre-clinical therapeutics, quality of care, diagnostics) with the proposal that provide a greater categorical resolution to the projects. These category tags may allow reviewers to better understand the context of the research and to more easily search proposals of interest.

The submission tab 218 may provide the author 104 with an ability to upload, preview, and submit the grant proposal. The submission tab 218 may also provide instructions and requirements for a format of the proposal. For example, the submission tab 218 may instruct the author 104 to prepare the proposal in a PDF format, as well as include specific information in the proposal, such as a title, abstract, introduction, detailed budget, specific aims and references. The submission tab 218 may also require the proposal to include additional information, such as links to unpublished data, unique expertise, assumptions, collaborators, as well as information for grant management purposes, such as deliverables, milestones, cost reports and a disbursement schedule for funding.

The proposal may be uploaded by any standard means. For example, the author 104 may trigger an uploading process by activating a file source browser within the submission tab 218, selecting a source of the proposal document, and uploading the proposal by activating an upload radio button, or similar means. The submission tab 218 may also provide the author 104 with an ability to preview the proposal prior to submitting it, or to save the proposal as a draft without submitting. Once the author 104 chooses to submit the proposal, the author 104 may do so by activating a submit trigger (e.g., submit radio button), at which point the submission tab 218 may prompt the author 104 to confirm the submission of the selected proposal.

Once the author 104 confirms submission of the proposal, the proposal submission module 210 may generate and assign a unique identification (ID) number to the proposal, generate and record the date and time of the submission, as well as prompt the author 104 with a text field for the author's name and title, which when entered by the author 104, may finalize the submission process. The name and title that the author 104 enters may be used by the proposal submission module 210 to populate a proposal-related CDA, which may later be used as a confidentiality agreement between the author 104 and each of the reviewers 106.

After the author 104 finalizes the submission of the proposal, the proposal submission module 210 may securely store the proposal in a storage module (not shown) and generate a proposal entry for the submitted proposal in a form of a digital proposal card 108, which may include various information identifying the proposal and reflecting the funding status of the proposal.

For each user (e.g., author 104, reviewer 106) that has completed the registration process and obtained their unique access credentials, a dashboard module 220 may generate a unique dashboard space specific to that user. The dashboard space provides a secure and dynamic environment that is accessible only via the corresponding access credentials. When an author 104 or a reviewer 106 logs on to the portal 102 using their access credentials, the dashboard module 220 will display the dashboard space to the user on the user's respective access terminal.

The dashboard module 220 may display the digital proposal card 108 on the dashboard space belonging to the author 104, as well as on dashboard spaces belonging to those reviewers 106 to whom the author has granted access to the proposal in the permission tab 212.

Each of the proposal cards 108 may show, e.g., the unique ID of the proposal, a photograph of the author 104, a link to the user's profile, indicate the user's position and the institution the user works for, as well as the user's country of origin by way of a flag image, for example. In addition, the proposal card 108 may display a number of unique views representing the number of different users that have accessed the proposal and a number of total views that represents the total number of times the proposal has been accessed. The card 108 may also display the number of comments in an author forum and/or a reviewer forum specific to the proposal. Furthermore, the proposal card 108 may display a progress bar that indicates the pledge status of the proposal, such as anywhere from zero to one hundred percent complete, or greater than one hundred percent. The proposal card 108 may also indicate the number of backers (i.e., number of foundations that have pledged funds to the proposal), the amount of pledges, the dollar amount of the pledges, and the requested dollar amount for the proposal. All of the information provided on the proposal card 108 may be intended to provide an at-a-glance summary of the funding status of the proposal.

The author 104 may access the proposal through the proposal card 108. If the author 104 has submitted multiple proposals, the author 104 may see a proposal card 108 for each one of those proposals on the author's respective dashboard space. If the author 104 also happens to be a reviewer 106, the author/reviewer may also be able to see proposal cards 108 for other authors' proposals that the author/reviewer is authorized to access.

As previously mentioned, when a reviewer 106 logs on to the portal 102 using access credentials, the reviewer will be presented with a unique dashboard space. Upon entry into the dashboard space, the reviewer 106 may be presented with one or more proposal cards 108. At this point, the proposal cards 108 display only limited information, e.g., they may not display or link to any confidential information (such as title, project summary, proposal, etc.). The reason that the reviewer 106 may not have access or permission is because the author 104 may not yet have given the reviewer permission to do so. The proposal cards 108, however, will include a link that, once clicked, may trigger a permission structure module 222 to establish a means for the reviewer 106 to directly contact the author 104 to request permission to view the proposal corresponding to the proposal card 108. For example, the permission structure module 222 may generate an alert or email directed to the author 104 that informs the author 104 that a reviewer 106 is requesting access to a specific proposal.

If the reviewer 106 requests access to the proposal through a link on the proposal card 108, and the author 104 grants the reviewer 106 access to the proposal, then the reviewer 106 may receive an alert or e-mail indicating that the reviewer 104 now has permission to access the proposal. Alternatively, the author 104 may independently invite the reviewer 106 through the permission structure module 222.

It should be noted that, upon submission of a proposal by the author 104, the permission structure module 222 may retrieve the list of reviewers 106 to whom the author 104 has granted permission to view the proposal in the permission tab 212, and transmit alerts to the reviewers on that list.

When the reviewer 106 is granted permission to view a proposal, the corresponding proposal card 108 displayed in the dashboard space of the reviewer 106 may show additional information about the proposal (e.g., title of the proposal). The proposal card 108 may also provide the reviewer 106 with the ability to access the project proposal, such as via a hyperlink or similar means. When the reviewer 106 clicks on the hyperlink to access the proposal for the first time, the permission structure module 222 may generate a proposal-related CDA and may prompt the reviewer 106 to sign the proposal-related CDA. In order to proceed to the proposal, the reviewer 106 must execute the proposal-related CDA by typing the reviewer's name in a designated field on the proposal-related CDA. Once the proposal-related CDA is executed, the permission structure module 222 may grant the reviewer 106 full access to the proposal.

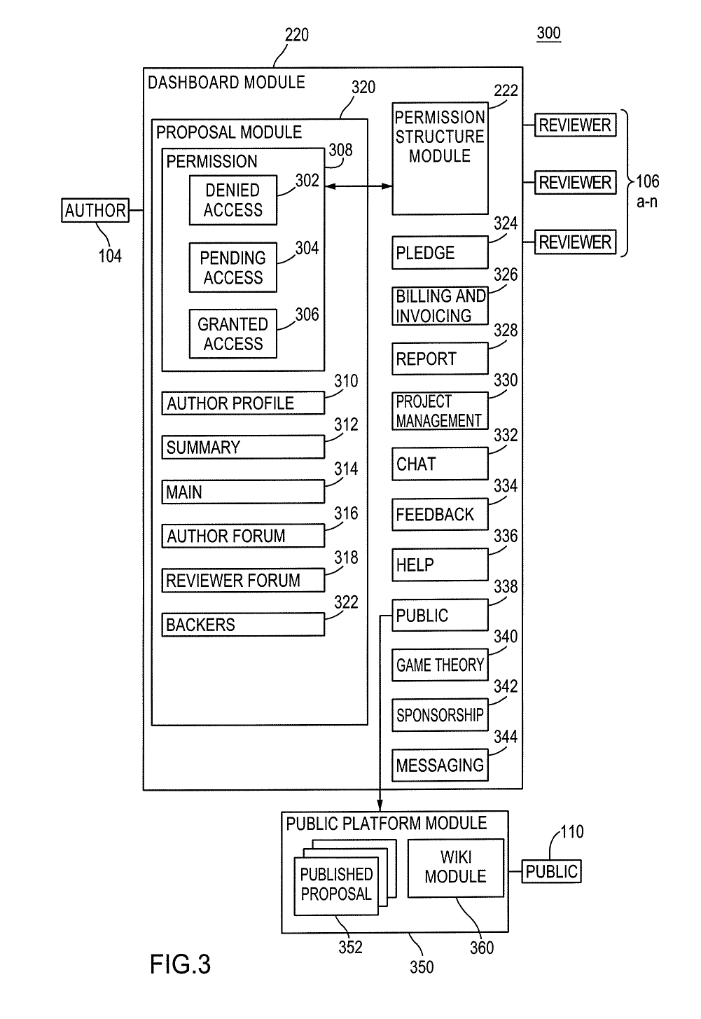

FIG. 3 is an example block diagram illustrating a system 300 for managing a proposal access permission structure between authors and reviewers and accessing a proposal via a dashboard module.

As shown in FIG. 3, the portal 102 may include a proposal module 320. The proposal module 320 may be configured to generate a proposal space that facilitates review, management and funding of proposals. For example, for each submitted proposal, a proposal module 320 may generate a unique proposal space specific to that proposal. The proposal space provides a secure and dynamic environment that is accessible only via the author of that proposal and any reviewers that have been granted access to that specific proposal and have executed the proposal-related CDA for that proposal. The generated proposal space, however, may differ somewhat depending on whether the author 104 of the proposal or the reviewer 106 is accessing the proposal space.

When an author 104 of the proposal enters the proposal space, the proposal module 320 may display to the author 104 a plurality of tabs, each of which may serve a specific purpose in the proposal management and review process. For example, the proposal space tabs may include a permission tab 308, an author profile tab 310, a summary tab 312, a main tab 314, an author forum tab 316, and a backers tab 322, among other tabs.

In addition to the tabs, the proposal space may include other features, such as a progress bar showing a percentage of how much of the total requested amount has been pledged, a pledge function that allows the author 104 to pledge funds to his own proposal, as well as a pledge edit function, which allows the author 104 to edit a previously made pledge.

The permission tab 308 may display a set number, such as three categories of reviewers. The first category may be a denied access category 302, which lists those reviewers that have not yet been given permission by the author to view the proposal. The reviewers listed under the denied access category 302 could, for example, include a competitor or someone with a potential conflict of interest, or the author 104 may not yet know that this reviewer exists. Reviewers listed in the denied access category 302 may be unable to access the proposal space. Furthermore, any reviewers that have been granted access to the proposal space may be unable to contact or discuss the proposal with the reviewers listed in the denied access category 302.

The second category of reviewers may be a pending access category 304, which may list those reviewers that have been given permission by the author to view the proposal but have not yet executed the proposal-related CDA. This list may include photographs of these reviewers and links out to their profiles, among other attributes. Reviewers listed in the pending access category 302 may be unable to access the proposal space. Furthermore, any reviewers that have been granted access to the proposal space may also be unable to contact or discuss the proposal with the reviewers listed in the pending access category 304.

The third category of reviewers may be a granted access category 306, which may list those reviewers that have permission from the author 104 to view the proposal and have also executed the proposal-related CDA. Reviewers listed in the granted access category 306 may access the proposal space and may also be able to contact or discuss the proposal with the other reviewers listed in the granted access category 306.

It should be noted that the categories and lists of reviewers in the permission tab 308 may be utilized by the permission structure module 222 to manage access to the proposal space and may ensure that only reviewers that are listed under the granted access category 306 are permitted to enter the proposal space.

The author profile tab 310 may include a profile of the author of the proposal. The author profile tab 310 may include resume or a curriculum vitae information that were previously submitted during the registration process and refined during the proposal submission process. The author profile tab 310 may also include e-mail addresses, and may have links out to other websites.

The summary tab 312 may include basic information that the author has entered in the author's respective summary section during proposal submission. For example, the summary tab 312 may include the title, the pledging status, the amount of money pledged, the category of the proposal, suggested mechanism of action, target population, tags, start and completion dates, budget, and the abstract, among other attributes.

The main tab 314 may include the proposal that the author uploaded and submitted during the proposal submission process. For example, the main tab 314 may include a PDF of the proposal, which may be viewed, printed, or downloaded by the user browsing the main tab 314.

The author forum tab 316 may include a forum specifically intended for discussion of the proposal between the author and the reviewers. The author forum may be in a form of a threaded message board. For example, if a reviewer has questions for the author, the reviewer can post the questions in the author forum. Comments posted to the forum may include the poster's photograph, name, a link out to the poster's profile, the poster's position in the foundation, as well as the poster's country of origin, among other attributes. Only the author and those designated under the granted access category 306 may read, post and reply to posts on the forum. The comments on the forum may be edited and deleted.

The reviewer forum tab 318 may include a forum specifically intended for discussion of the proposal exclusively among reviewers who have been granted access to the proposal space. The author of the proposal may not have access to the reviewer forum tab 318. Moreover, the reviewer forum tab may not be displayed in the author's proposal space—it may be available only to the reviewers. The reviewer forum may be in a form of a threaded message board. Excluding the author from the reviewer forum provides the reviewers with an opportunity for a candid, critical review that the reviewers may share with each other but not with the author. The reviewer forum allows for crowd sourcing of scientific advisors. For example, when a scientific advisor from one foundation leaves a comment on the reviewer forum, the comment can be shared with any other foundation or foundation member that has been granted access to the proposal as a reviewer.

The backers tab 322 may include a list of individuals that have actually pledged funds to the project proposal and may provide an updated status of the pledges and funding. The backers tab 322 may list the backers with their profile photograph and brief biography that may include a link that allows a user access to the backer's profile. The backers tab 322 may also show how much each backer has pledged and may indicate the status of the funding. The backers tab 322 may also include a field where the author or a liaison may be able to indicate if funding from the sources that pledged the funds has been received.

The proposal space may also include a pledge module 324 that may be activated by having a user click on or otherwise select a pledge link. When activated, the pledge module 324 may display to the user a pledge space that may include various information regarding the pledge, such as the total proposal budget, the total amount requested by the author, and a summary of the sum of the pledges that had already been provided by other users, among other attributes. The pledge space may also include a field where the user may enter a pledge amount. The user may enter a pledge amount and trigger a pledge submission by, for example, clicking or otherwise selecting a submit button. At this point, the pledge module 324 may activate a comment box where the user who just triggered the pledge submission may leave a comment associated with that pledge. The user may fill in the comment and click a button to submit the pledge and comment together. The pledge comment may be directly associated with the user who made the pledge and may be displayed in the pledge space with the pledge information for the user. Once the submission is made, the pledge module 324 may update the pledge related information throughout the proposal space. For example, the pledge module 324 may update the backers tab 322 to list the new user that made the pledge as a new backer. Also, the proposal card 108 on the dashboard space may be updated with the new pledge amount. For example, the progress bar on the proposal card 108 that indicates the percent funded may be updated to reflect the new pledged amount.

Every time a pledge is submitted or edited, an alert may be transmitted by the pledge module 324 to the author and the reviewers that have been granted access, indicating the user making the pledge and the pledged amount for the project proposal.

The pledge space and the backers tab 322 may include a pledge status indicator for each of the individuals that have pledged funds. The submission of a pledge is recorded as well as the transfer of the money either to the liaison or to the author may also be recorded by the pledge module 324. The liaison or author may then indicate whether or not the pledged amounts have been received. The indication may be reflected in a pledge status field as either “pending” if the pledge has not yet been funded, or “fulfilled” if the pledge has been funded.

The dashboard module 220 may include a billing and invoicing module 326, which may provide for the ability to transfer electronic funds between the reviewers and the liaison or author. For example, the reviewers (e.g., foundations) may electronically transfer money to the liaison (e.g., via credit card, PayPal, or other means) and then the liaison can disburse the transferred amount by check or through the billing and invoicing module 326 to the author.

The dashboard module 220 may also include a report module 328, which may generate summary reports including with various statistical information, such as the number of active proposals in the portal 102, the total amount of funds requested through the portal 102, the total amount pledged through the portal 102, and the total number of registered users. The report module 328 may generate reports on any measurable statistic within the portal 102. The reports may be available to users through different permissions.

The dashboard module 220 may additionally include a project management module 330 that may facilitate the management of grant proposals within the portal 102. For example, for each proposal, the proposal start and stop dates entered by the author 104 during registration may be incorporated into a project scheduling chart, such as a Gantt Chart, by the project management module 330. Various other budget, scheduling, and task-related information may be provided by the author and similarly incorporated in to the project scheduling chart by the project management module 330.

The project management module 330 may be integrated with a calendar so that start dates of particular aims scheduled by the author may show up as a date on a calendar. Other information may be included in the calendar, such as information for drug seminars, fund-raising events, etc. Deliverables and milestones, such as publications and other project-related events that occur throughout the lifetime of the project proposal may be also displayed on the calendar, such as a timeline, and the project-scheduling chart associated with the proposal, among other events/milestones.

The project management module 330 may function in tandem with the report module 328 to provide any generated reports to users through the permission structure module 222. For example, if the reviewer has been granted access, the reviewer can see all this information within the report; whereas if the reviewer has not been granted access, the confidential information will be invisible to the reviewer.

The dashboard module 220 may also include a chat module 332 that may be used by authors and reviewers to contact other registered users through an alphabetical list.

The dashboard module 220 may also include a messaging module 344 that may be used by authors and reviewers to contact other registered users through a link associated with each user's profile.

The dashboard module 220 may also include a feedback module 334 that allows all registered users to provide feedback by capturing an image of the dashboard space, proposal space, or any other displayed environment within a web browser along with an Internet Protocol (IP) address of the user.

The dashboard module 220 may also include a help module 336 that may include entries describing each module and component of the portal 102, and that may allow users to annotate those entries and “vote up” entries. The help module 336 may thus provide an ability to crowd source helpful information about the portal 102.

The dashboard module 220 may also include a public module 338, which may generate a public version of proposals that may be published on the public platform module 350, such as a web page that is accessible to the public 110. For example, if an author chooses to create a public version of the author's proposal, that proposal may be displayed on the public platform module 350 where the public 110 may have the opportunity to pledge funds to as well as fund the proposal. The funding may be documented and reported to the authors 104 and the authorized reviewers by the public module 338. The reviewer/foundation funding for the published proposal may also be reported on the public platform module 350.

According to aspects of the invention, publication of a proposal to the public platform module 350 may be based on a plurality of states of various indicators. For example, the permission tab 308 may include a first indicator that the author may manually toggle to indicate an authorization for the proposal to be published on the public platform module 350, thus setting the first indicator to an authorized publication state. The public module 338 may also include an algorithm that may automatically toggle a second indicator to indicate whether reviewer/foundation funding of the proposal had reached a predetermined funding threshold (e.g., 25%), thus setting the second indicator to an authorized publication state. The public module 338 may also include a third indicator that the reviewers 106 may manually toggle to indicate an authorization for the proposal to be published on the public platform 350, thus setting the third indicator to an authorized publication state. The third indicator may be set to the authorized publication state either by a specific reviewer with administrative rights, or may be set by a plurality of reviewers through a voting system, or the like.

Additional indicators may factor into authorizing the proposal for publication, such as algorithms that calculate a number of reviews of the proposal, a number of comments the proposal has received, or any other measurable information that may be compared to a respective threshold. The public module 338 may automatically set each of the measurement-based indicators to an authorized publication state when the measured factors meet or exceed the respective predetermined thresholds. Any one or any combination of the aforementioned publication indicators, whether set manually or automatically, may be used by the public module 338 to publish the proposal to the public platform module 350.

The public module 338 may indicate the status of the publication of the proposal to the public platform module 350 by listing the term “public,” for example, under the appropriate category within the permission tab 308. For example, if the author 104 has toggled the first indicator to deny authorization for publication, then the term “public” may be listed under the denied access category 302. If the author 104 has toggled the first indicator to grant authorization for publication, but other required indicators have not yet been set to an authorized publication state, then the term “public” may be listed under the pending access category 304. If, on the other hand, all of the required indicators have been set to an authorized publication state, then the term “public” may be listed under the granted access category 306. Once the term “public” is listed under the granted access category 306, the public module 338 may publish the proposal, as a published proposal 352, to the public platform module 350.

The published proposal 352 in the public platform module 350 may be in the proposal card 108 form or some other form and may include a specified amount of information about the proposal. For example, the published proposal 352 may include only the information provided in the summary tab 312 or it may include a full PDF of the proposal as shown in the main tab 314. The amount of information published may be specified by the author 104 when toggling the first indicator to authorize publication.

Once the public module 338 publishes a public version of the proposal on the public platform module 350, the public 110 may view the published proposal 352 on the public platform module 350. The public platform module 350 may include a system for the public to register with the public platform module 350 by entering and submitting their personal information through various designated fields. Once a public user has registered, the public platform 350 may provide the registered user with various online tools that allow the user to provide comments, participate in forums, and receive updates on selected published proposals 352, as well as pledge money towards a proposal of the user's choice through various online financial transaction means (e.g., PayPal).

The public platform module 350 may include for each proposal an indication whether the proposal is supported in the private domain (e.g., by foundations). Furthermore, the combined amount of funding that the foundations/reviewers and the public 110 may provide represents the total funding. This merging of private and public funding may be represented on a progress bar on the published proposal 352 as well as on the proposal card 108, which may have a sum of these two numbers indicated in two different colors in the same bar.

The public platform module 350 may also include a wiki module 360, which may include non-confidential therapeutic information from the dashboard module 220 as well as therapeutic information independent of the dashboard module 220 that may be accessible by the public 110. The wiki module 360 includes information associated with drugs and development of these drugs. The wiki module 360 may allow public users to register and participate in adding information about various drugs. Once a user is logged in they can add a drug and associate the drug with a disease in a subpopulation. The user may then assign properties with the drug and categorize these properties using a tagging system, for example. For example, every property that is assigned to a drug may be considered a tag, and each drug may have a plurality of tags.

The wiki module 360 may include information on the opportunities for therapeutic development and the current stages of development of each drug. For example, information related to the stages of development may indicate whether the drug is in a preclinical development phase, phase one, phase two, phase three, or phase four, and whether the drug is commercially available, whether it is an NDA or an IND, a new drug application, or an investigational new drug, etc. The wiki module 360 allows a user to add references to support the properties associated with the drug through using various identifiers, such as a Pub Med ID, a digital object identifier, an NCT, or a URL, that point to and/or identify primary literature, government websites, public websites, or lay publications and press.

The wiki module 360 may use the added references (e.g., Pub Med ID) to directly link out to the referenced source and/or to automatically retrieve an abstract from the referenced source to associate with the property of the drug, and display the abstract to the user upon request. The wiki module 360 may also allow user commenting as well as scoring of the comments, drug properties, and references associated with the properties. The rating may be a numerical score that reflects the reliability of a reference. The wiki module 360 may also provide an ability for the user to sort and filter based on various properties and the magnitude and the quality score of those properties.

The wiki module 360 may visually represent all of the drug-related information by displaying to the user the different stages of development for each drug and the various supporting references. The wiki module 360 may also utilize other commenting, forum, and rating features previously discussed with reference to other modules, as well as the measurement and leader board features of the game theory module 340.

Aspects of the invention may include an application of game theory to measure contributions by each participant. For example, the dashboard module 220 may include a game theory module 340 that may process parameters, such as an amount of funding pledged or contributed by each user, a number of user comments, a rating of the comments, a number of proposals each user has reviewed or submitted, etc. The game theory module 340 may measure all analytics and report these measurements to the respective users to provide incentive for more participation. The game theory module 340 may also include a leader board, accessible by all authors 104 and reviewers 106, that presents all of the measurements for each user. The game theory module 340 may also associate a score with each user based on the various measurements, as well as other parameters, such as whether the user has signed the general CDA, the proposal CDA, added a profile picture, completed their personal profile, etc. The game theory module 340 may gather additional parameters related to user participation from all of the component modules within the portal 102 and adjust the score and leader board ranking of each user based on their respective participation within the portal 102.

The dashboard module 220 may also include a sponsorship module 342 that may allow each of the foundations to serve as a channel or portal to the portal 102. This may be achieved by having the sponsorship module 342 generate an application that may be remotely integrated into the foundations' own portals or websites, and that allows the foundations to display advertisements related to the portal 102. Such a sponsorship module 342 may allow increase in the reach and therefore an increase in value of the portal 102.

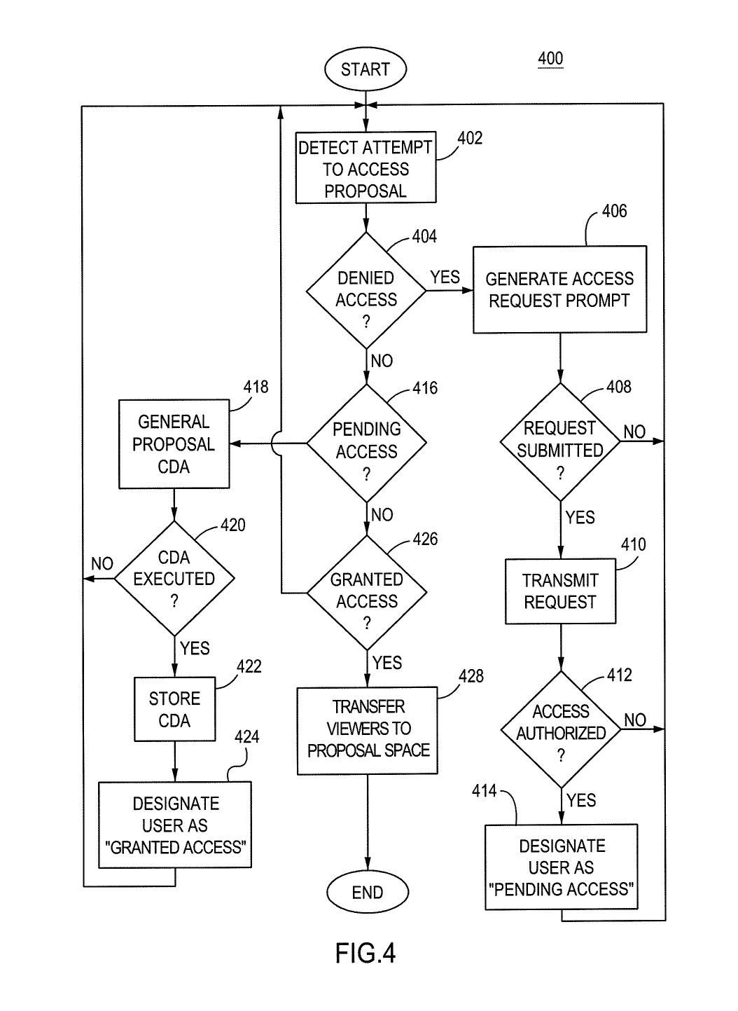

FIG. 4 illustrates an example flow diagram of a method 400 for accessing a proposal. As shown in FIG. 4, in block 402, an attempt to access a proposal may be detected. For example, the permission structure module 222 may detect a reviewer 106 attempt to access a proposal through a proposal card 108.

In block 404, a determination may be made as to whether the user attempting to access the proposal is within a denied access category for the proposal. If the user is within the denied access category, the process may proceed to block 406, otherwise the process may proceed to block 416. For example, the permission structure module 222 may search for the reviewer within the list of reviewers in the denied access category 302.

In block 406, an access request prompt may be generated for submission by the user to the author of the proposal. For example, the permission structure module 222 may generate a prompt to the reviewer attempting access indicating that the reviewer does not have permission to access the proposal and inquiring whether the reviewer would like to request permission from the author to access the proposal.

In block 408, a determination is made as to whether the request for access has been submitted by the user. If so, the process proceeds to block 410, otherwise, the process proceeds to block 402. For example, the permission structure module 222 may remain in standby while the reviewer either accepts or declines to send the permission request to the author.

In block 410, the request for access to the proposal may be transmitted to the author. For example, the permission structure module 222 may transmit an email or an alert to the author indicating that the reviewer is requesting access to view the proposal.

In block 412, a determination may be made as to whether an authorization for the user to access the proposal has been received from the author. If the author authorizes access, the process proceeds to block 414; otherwise, the process proceeds to block 402. For example, the permission structure module 222 may receive authorization from an author permitting the reviewer to access the proposal, or a refusal denying the reviewer access to the proposal.

In block 414, the user may be designated with the pending access status. For example, the permission structure module 222 may toggle the permission status of the reviewer for this particular proposal as “pending access,” and list the reviewer in the pending access category 304. The process may then proceed back to block 402.

In block 416, a determination may be made as to whether the user attempting to access the proposal is within a pending access category for the proposal. If the user is within the pending access category, the process may proceed to block 418; otherwise the process may proceed to block 426. For example, the permission structure module 222 may search for the reviewer within the list of reviewers in the pending access category 304.

In block 418, a proposal-related CDA may be generated with a prompt for the user to execute. For example, the permission structure module 222 may generate a proposal-related CDA with a text filed for the reviewer to enter the user's name and/or signature and other information and thereby execute the CDA.

In block 420, a determination may be made whether the user executed the proposal-related CDA. If so, the process may proceed to block 422; if not, the process may proceed to block 402. For example, the permission structure module 222 may detect an acceptance of the proposal-related CDA by detecting a reviewer's name typed into a text field and a submittal action.

In block 422, the proposal-related CDA may be stored and displayed in the user's and author's respective profiles. For example, the permission structure module 222 may store the proposal-related CDA in server storage and also display the CDA in the author's profile as well as the reviewer's profile.

In block 424, the user may be designated with granted access status. For example, the permission structure module 222 may toggle the permission status of the reviewer for this particular proposal as “granted access,” and list the reviewer in the granted access category 306. The process may then proceed back to block 402.

In block 426, a determination may be made as to whether the user attempting to access the proposal is within a granted access category for the proposal. If the user is within the granted access category, the process may proceed to block 428; otherwise the process may proceed to block 402. For example, the permission structure module 222 may search for the reviewer within the list of reviewers in the granted access category 304.

In block 428, the user may be transferred to the proposal space, and the process may end. For example, the permission structure module 222 may grant the reviewer access, via the proposal module 320, to the secure proposal space that includes all information related to the proposal.

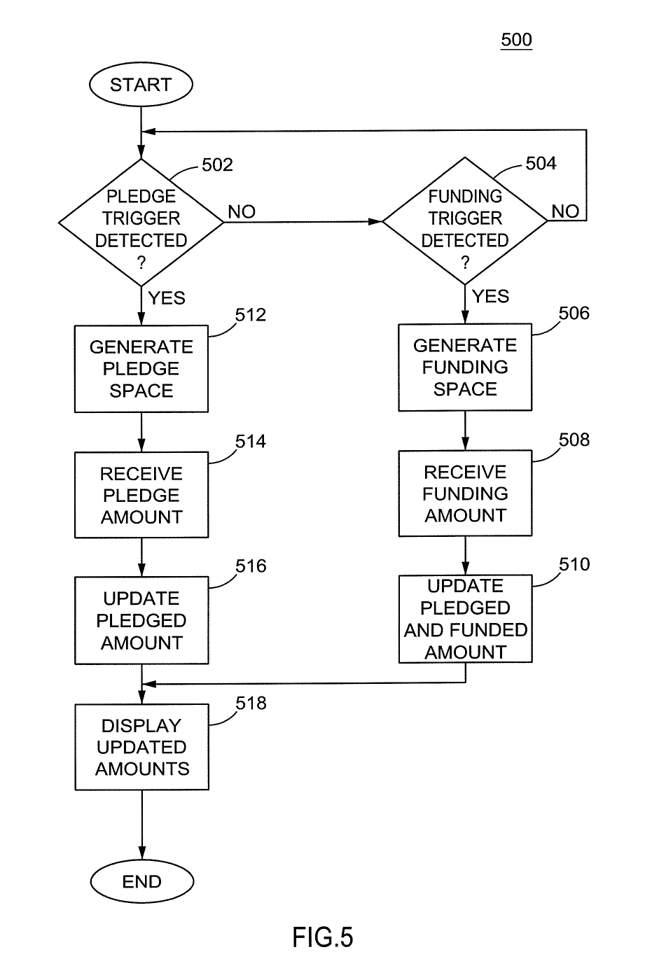

FIG. 5 illustrates an example flow diagram of a method for pledging funds to and funding a proposal. As shown in FIG. 5, the process may begin with block 502, where a determination may be made as to whether a pledge trigger has been detected. If so, the process may proceed to block 512; otherwise, the process may proceed to block 504. For example, a pledge module 324 may detect an indication of a pledge submittal attempt, such as when a pledge link has been clicked.

In block 504 a determination may be made as to whether funding trigger has been detected. If so, the process may proceed to block 506; otherwise, the process may proceed to block 502. For example, the pledge module 324 may detect an indication of a fund transfer towards a proposal budget, such as when an author or a liaison for the author clicks on a pledge funded link.

In block 506, a funding form may be generated. For example, the pledge module 324 may generate a funding space with a text field for entry of the funded amount.

In block 508, a funded amount may be submitted, and the process may proceed to block 510. For example, the pledge module 324 may detect an entry and submission of a funded amount.

In block 510, the funded and pledged amounts for the proposals may be updated, and the process may proceed to block 518. For example, the pledge module 324 may update the pledged and funded amounts to reflect the submission of the funded pledge. This tool may be used to track the transfer of money between users including, for example, reviewers, liaisons, and authors or authors' institutions.

In block 512, a pledging form may be generated. For example, the pledge module 324 may generate a pledge space with a text field for entry of the pledged amount.

In block 514, a pledged amount may be submitted, and the process may proceed to block 516. For example, the pledge module 324 may detect an entry and submission of a pledged amount.

In block 516, the pledged amounts for the proposals may be updated, and the process may proceed to block 518. For example, the pledge module 324 may update the pledged amounts to reflect the submission of the new pledge.

In block 518 the funded and pledged amounts for the proposals may be updated throughout the proposal space, and the process may end. For example, the pledge module 324 may update, via the proposal module 320, all instances representing the pledged and funded amounts to reflect the submission of the pledged and/or funded amounts. For example, one of the instances of the pledged and funded amounts that may be updated are those displayed on the project card 108.

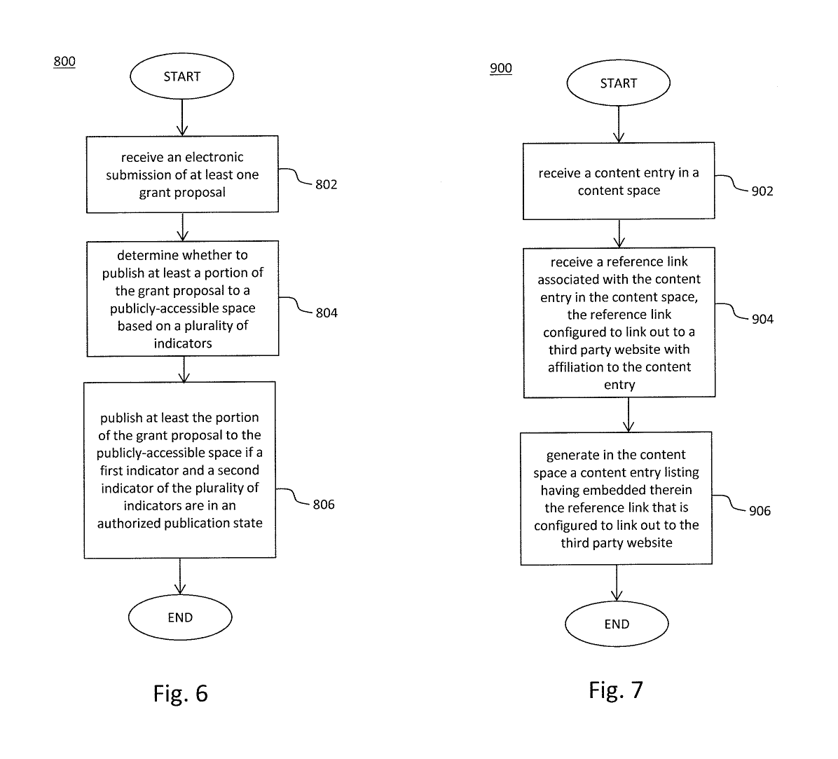

FIG. 6 illustrates an example flow diagram 800 of a method for publishing a proposal. As shown in FIG. 6, the process may begin with block 802, where an electronic submission of at least one grant proposal may be received. For example, a proposal module 320 may receive a proposal 108.

In block 804 a determination may be made whether to publish at least a portion of the grant proposal to a publicly-accessible space based on a plurality of indicators. For example, the public module 338 may determine whether to publish the proposal 108 to the public platform module 350 based on a plurality of indicators.

In block 806 at least the portion of the grant proposal may be published to the publicly-accessible space if a first indicator and a second indicator of the plurality of indicators are in an authorized publication state. For example, the public module 338 may publish a public version of the proposal 108 (i.e., published proposal 352) to the public platform module 350 if certain indicators are in an authorized publication state.

FIG. 7 illustrates an example flow diagram 900 of a method displaying therapeutic information in a web-based environment. As shown in FIG. 7, the process may begin with block 902, where a content entry is received in a content space. For example, the wiki module 360 may receive content entries regarding therapeutic drugs.

In block 904 a reference link associated with the content entry is received in the content space, the reference link configured to link out to a third party website with affiliation to the content entry. For example, the wiki module 360 may receive a reference link entry.

In block 906 in the content space is generated a content entry listing having embedded therein the reference link that is configured to link out to the third party website. For example, the wiki module 360 may generate the contact entry associated with the therapeutic drug having imbedded therein a reference link to a third party website.

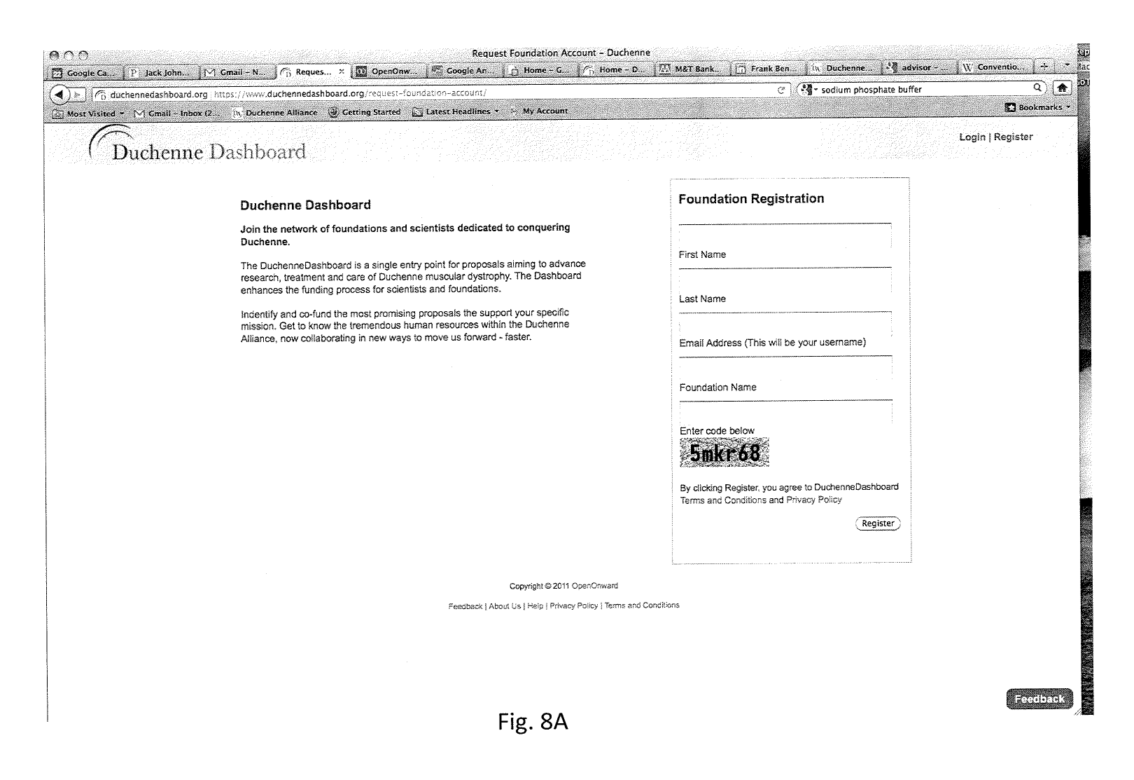

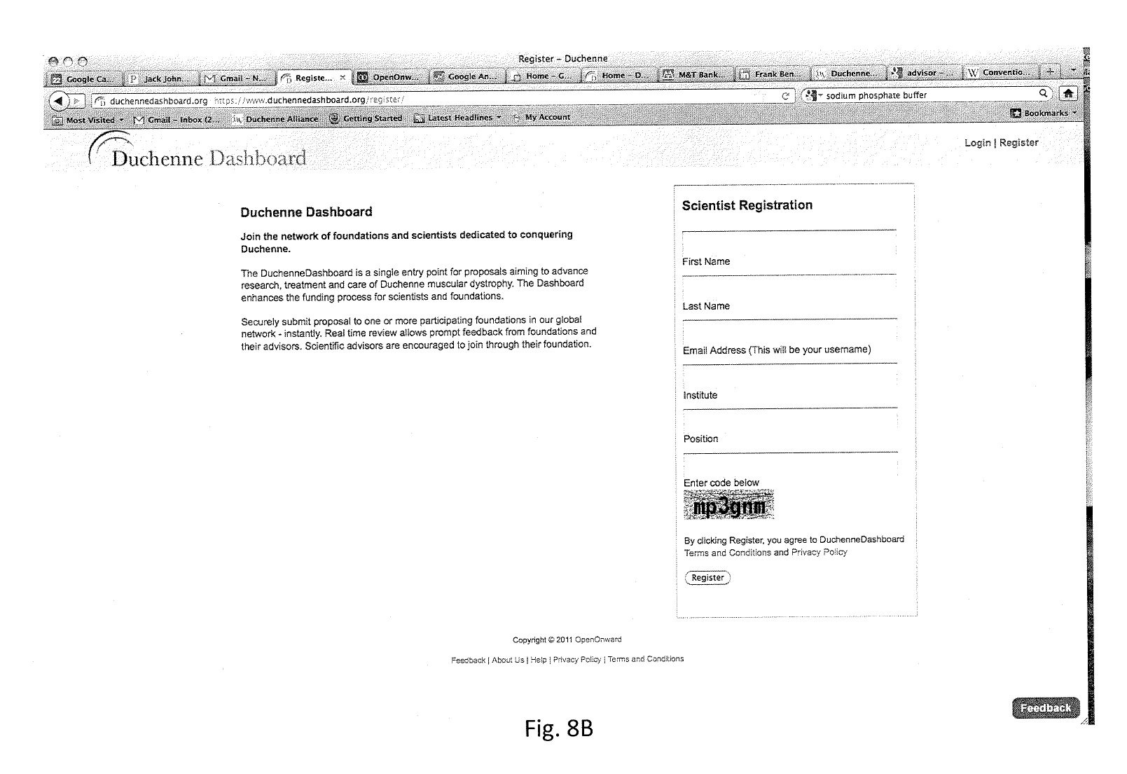

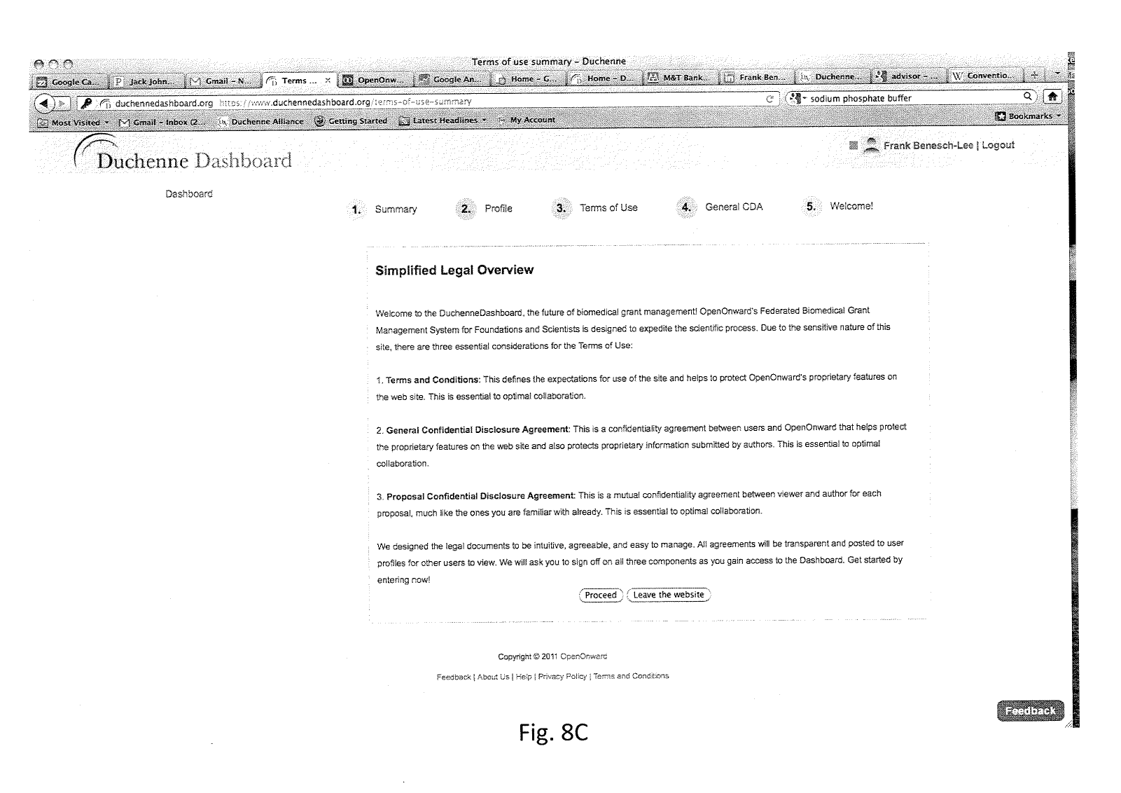

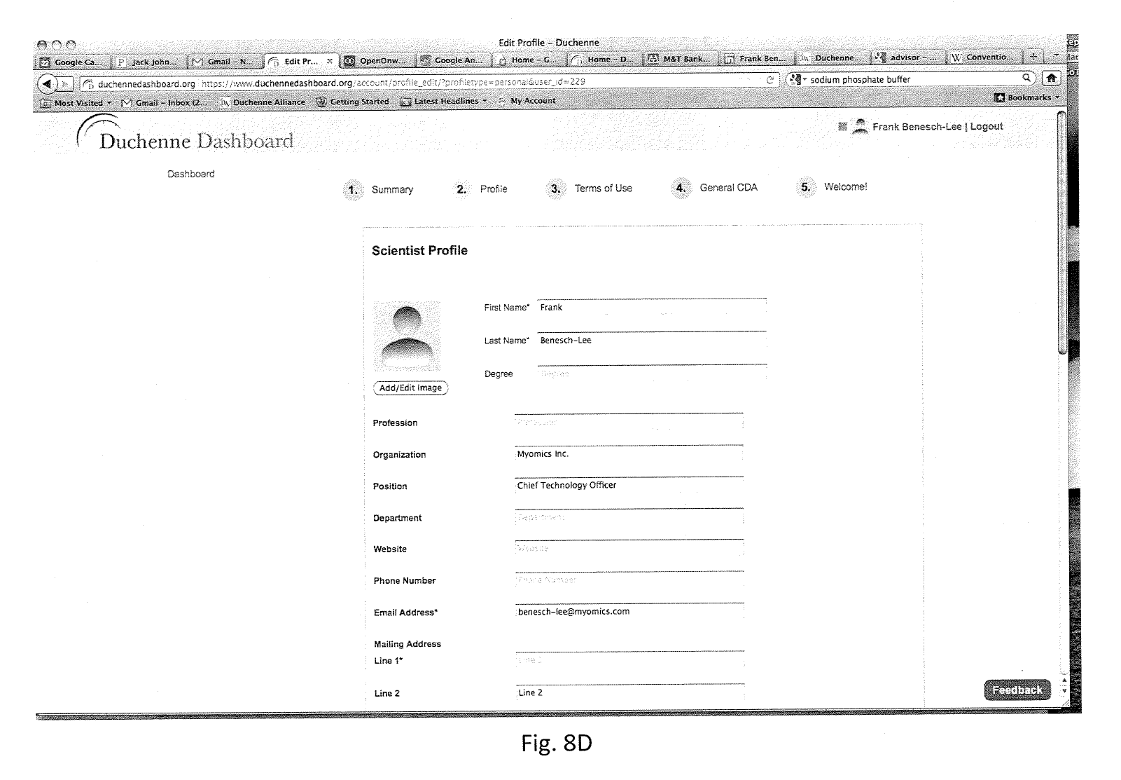

FIGS. 8A-8D illustrate example screen shots of a registration process in accordance with aspects of the present invention.

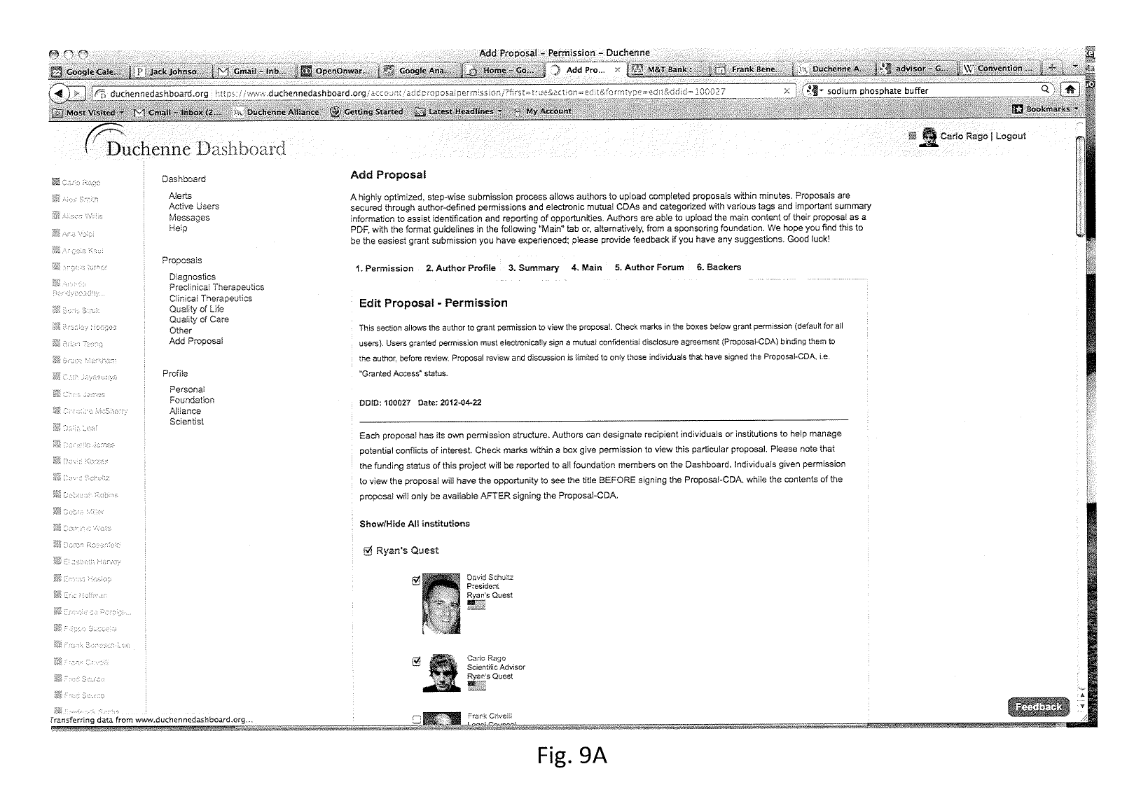

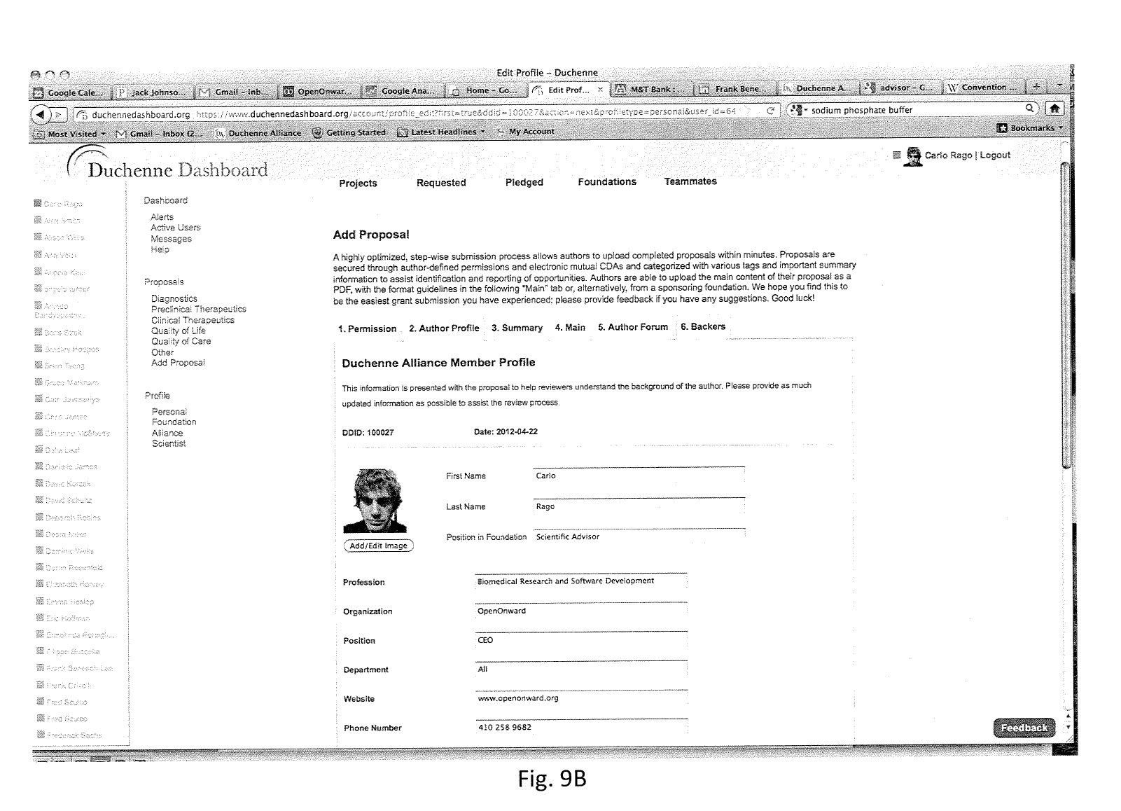

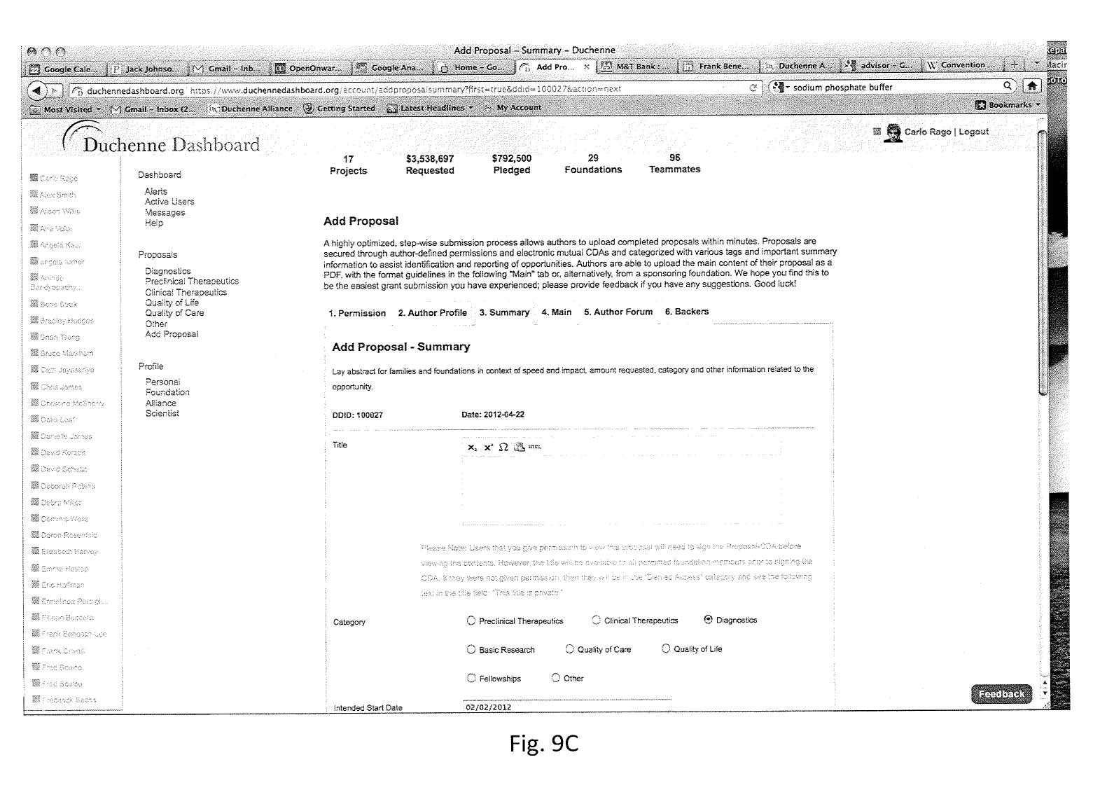

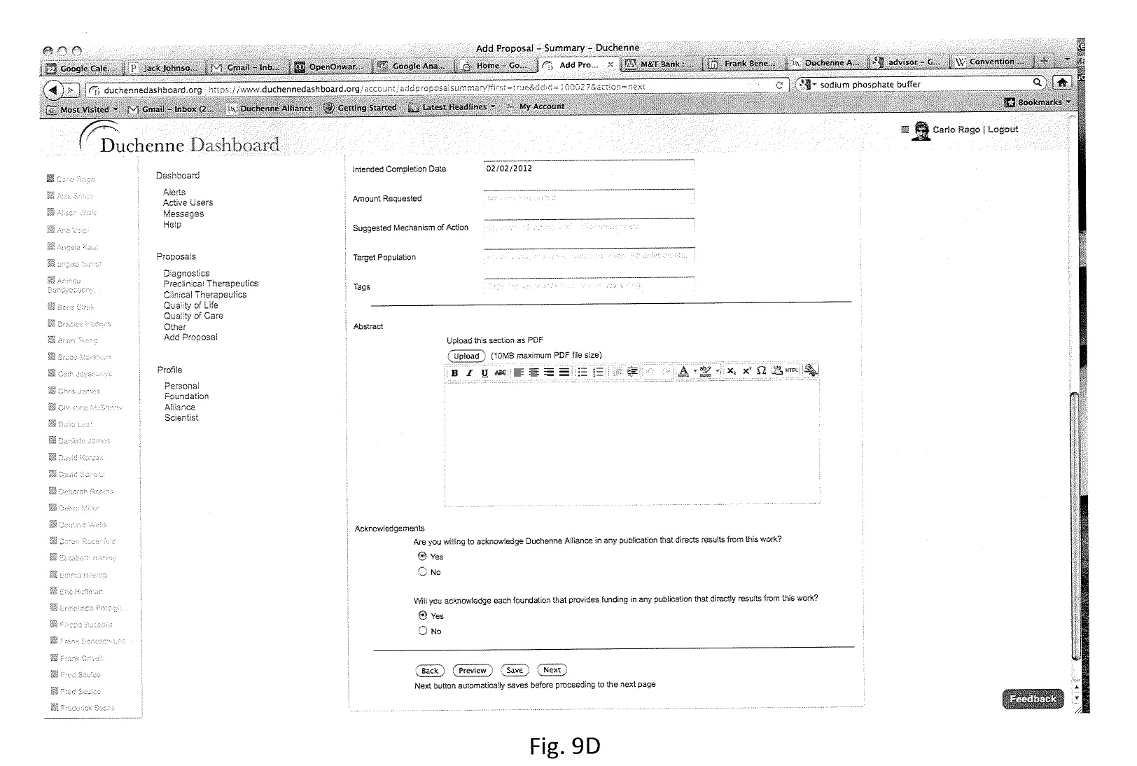

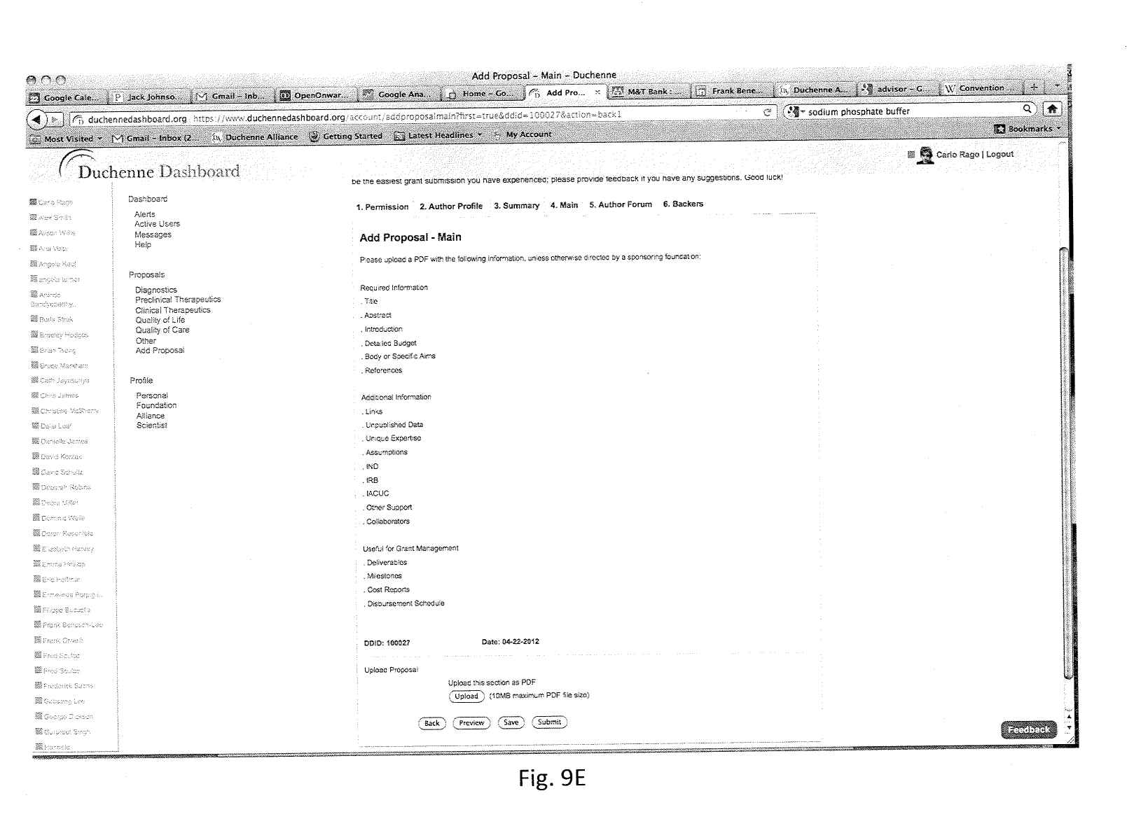

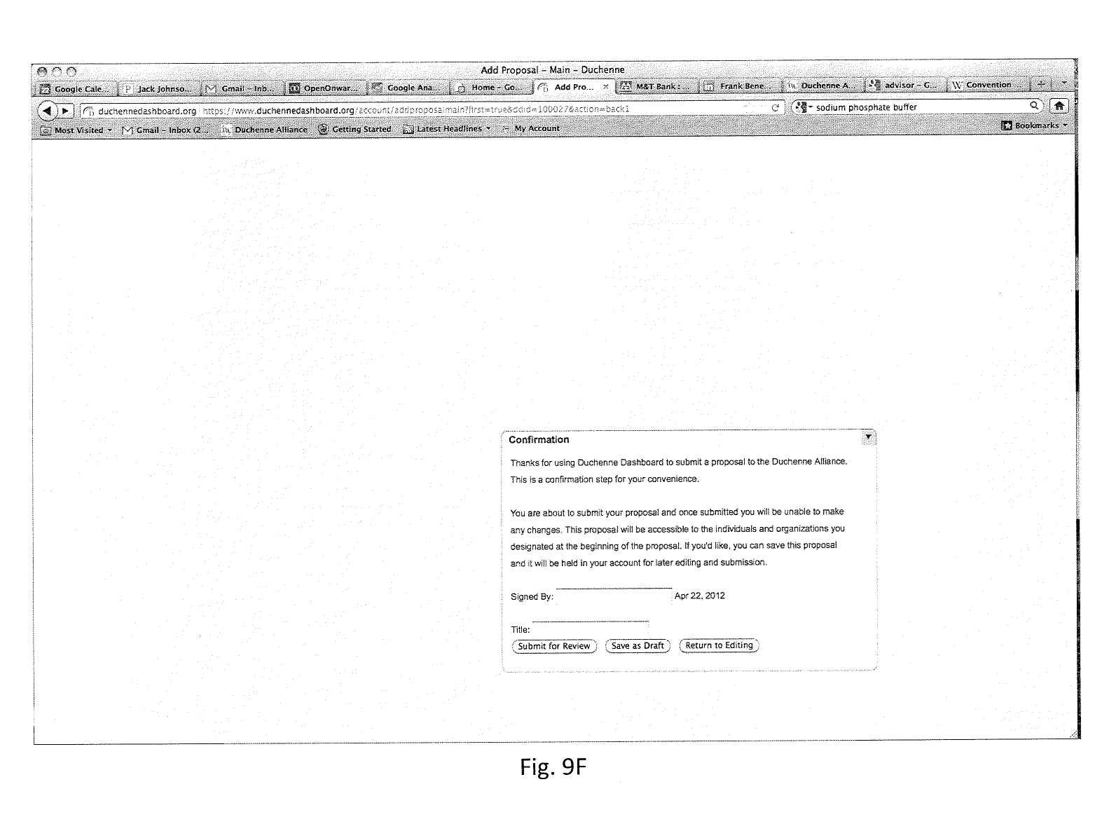

FIGS. 9A-9F illustrate example screen shots of a proposal submission process in accordance with aspects of the present invention.

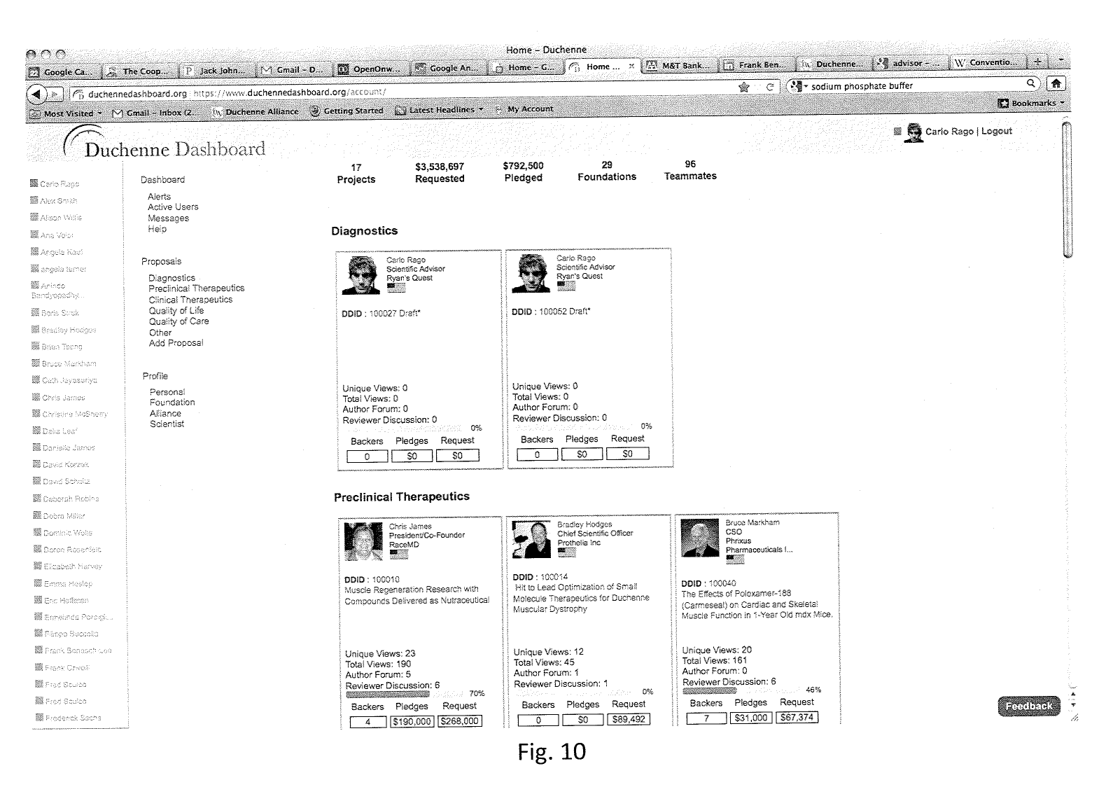

FIG. 10 illustrates an example screen shot of a dashboard space in accordance with aspects of the present invention.

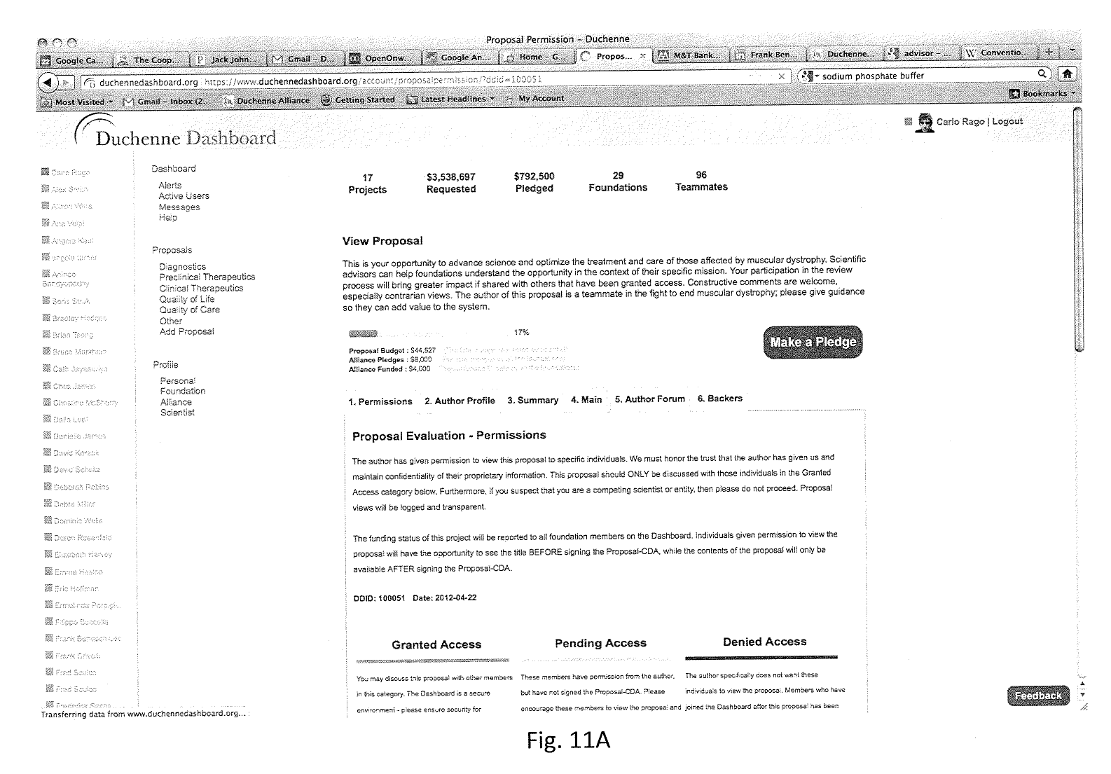

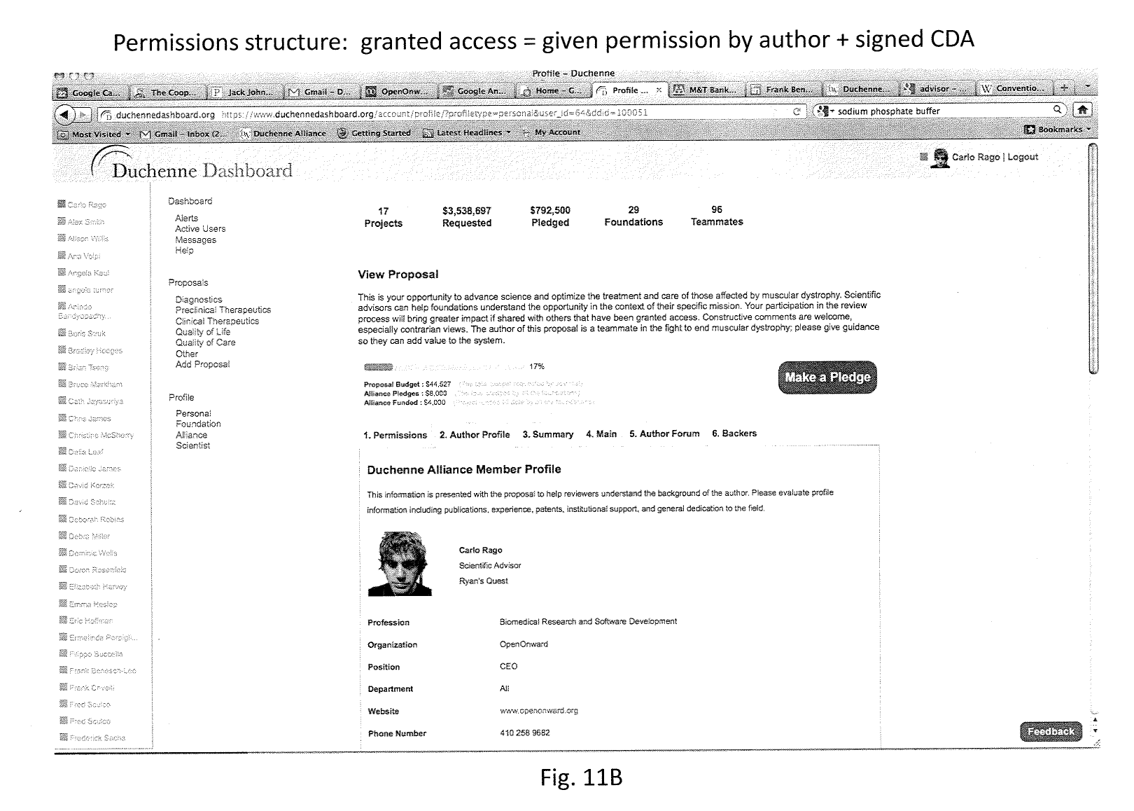

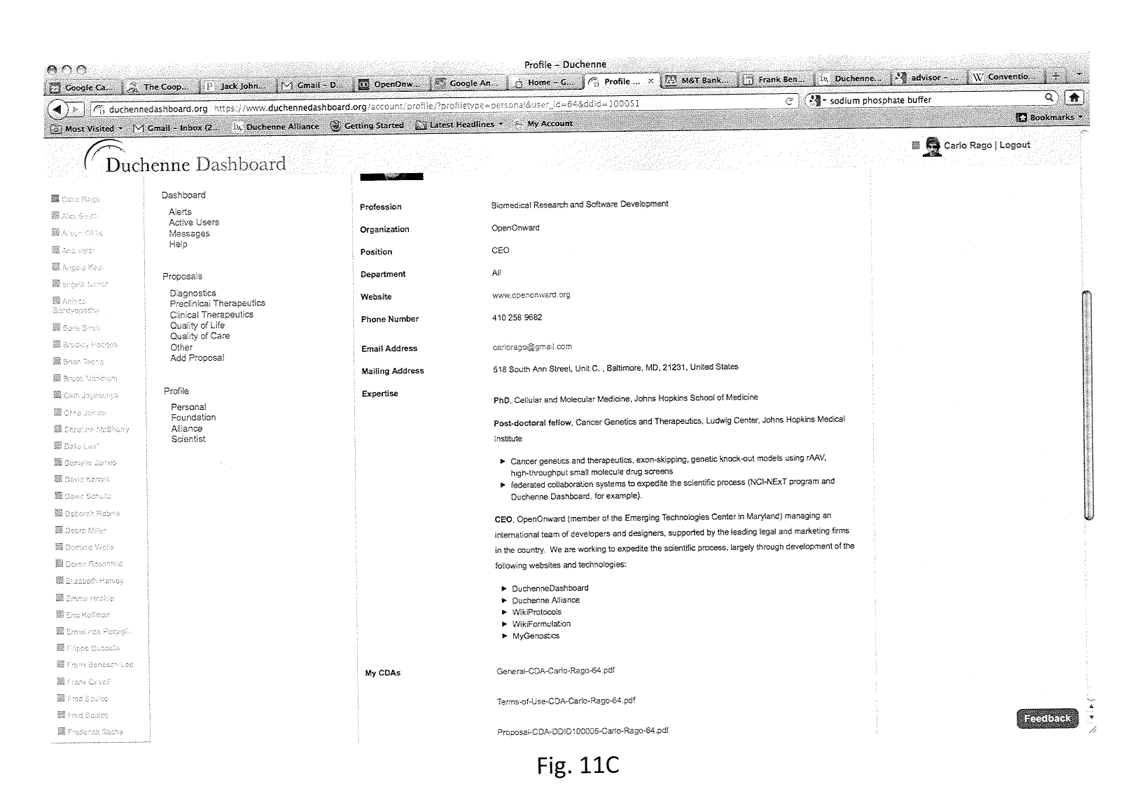

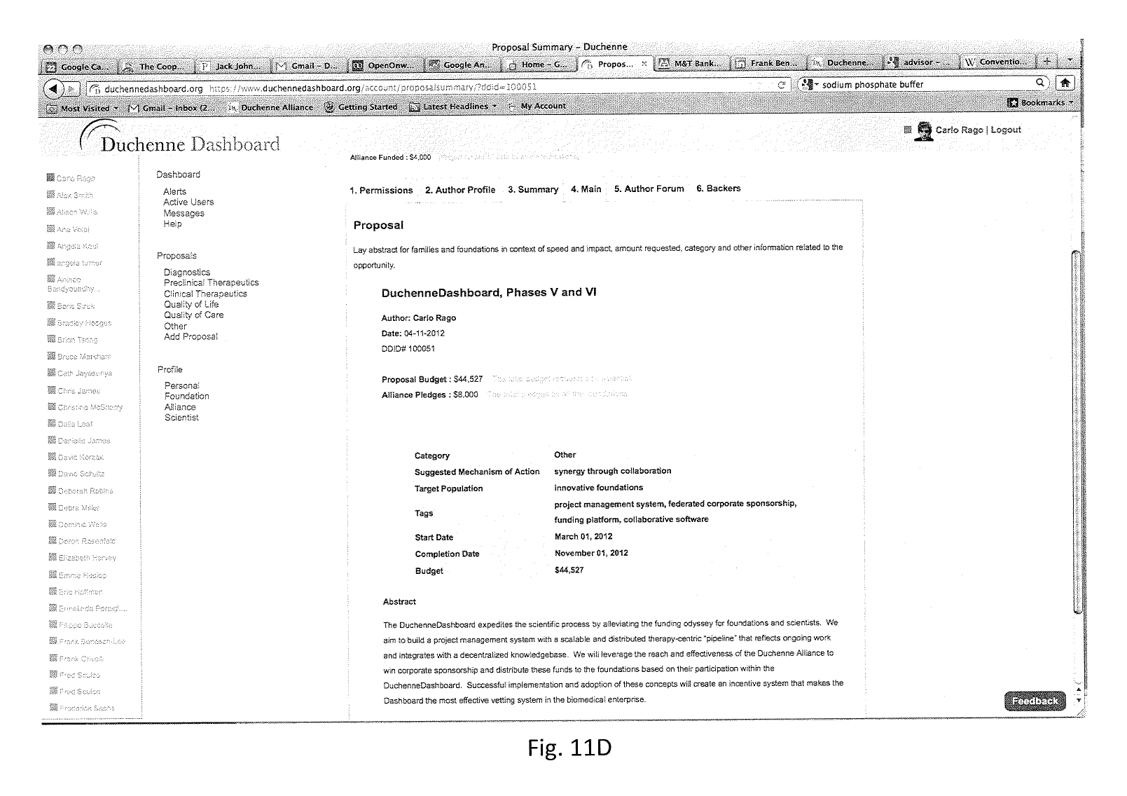

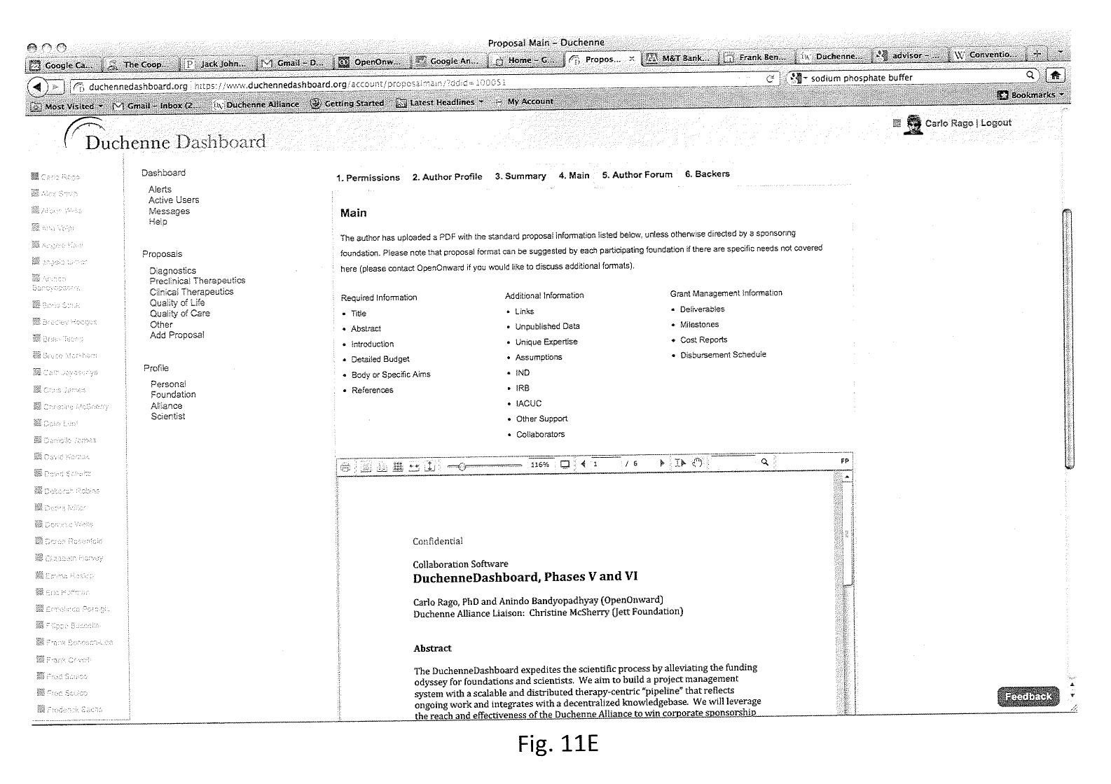

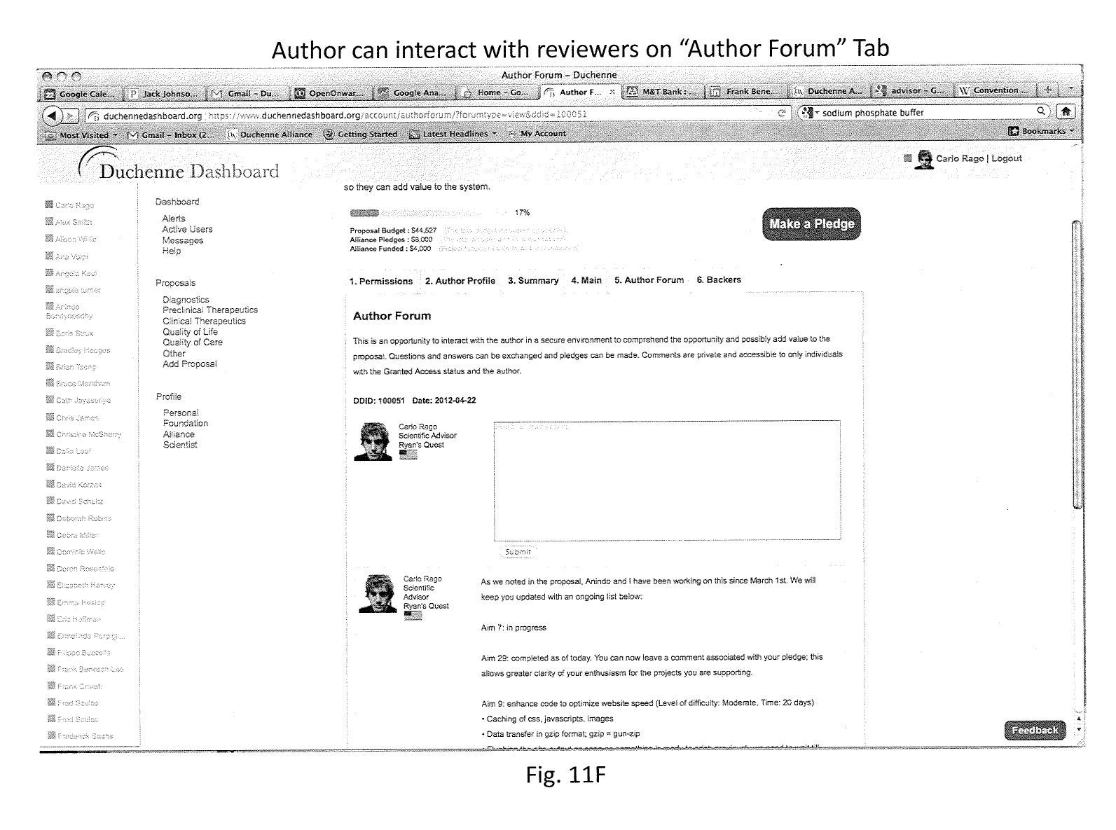

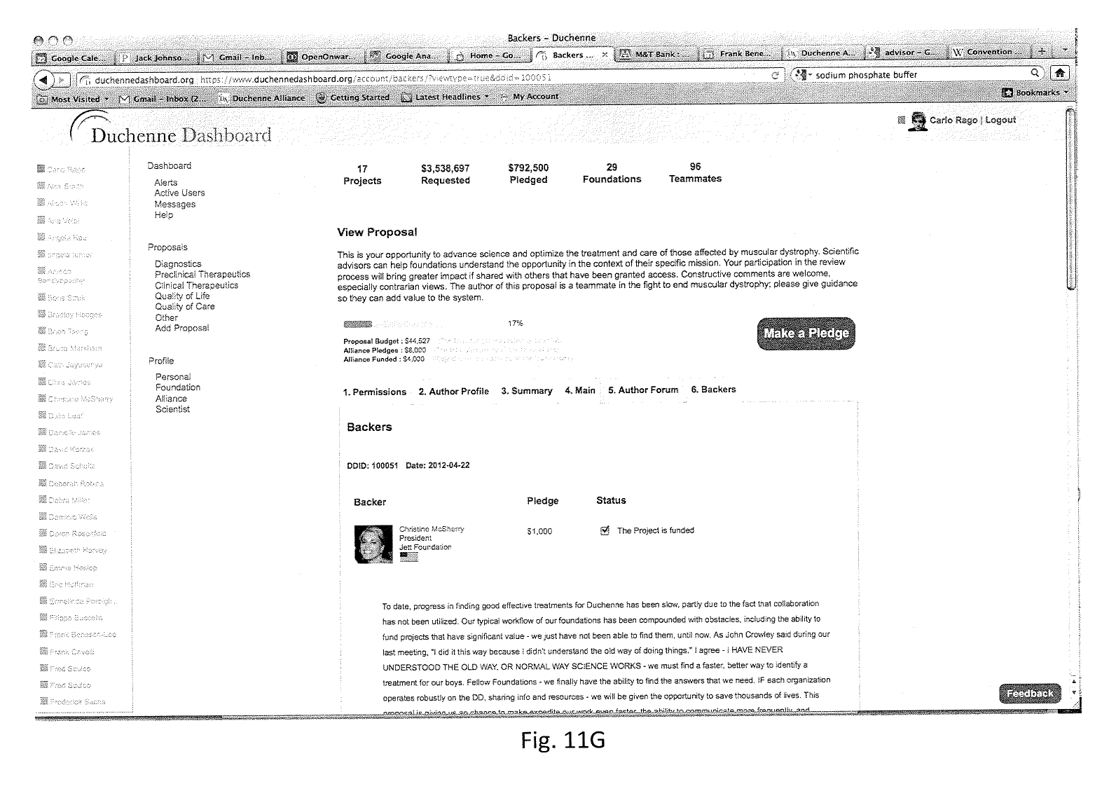

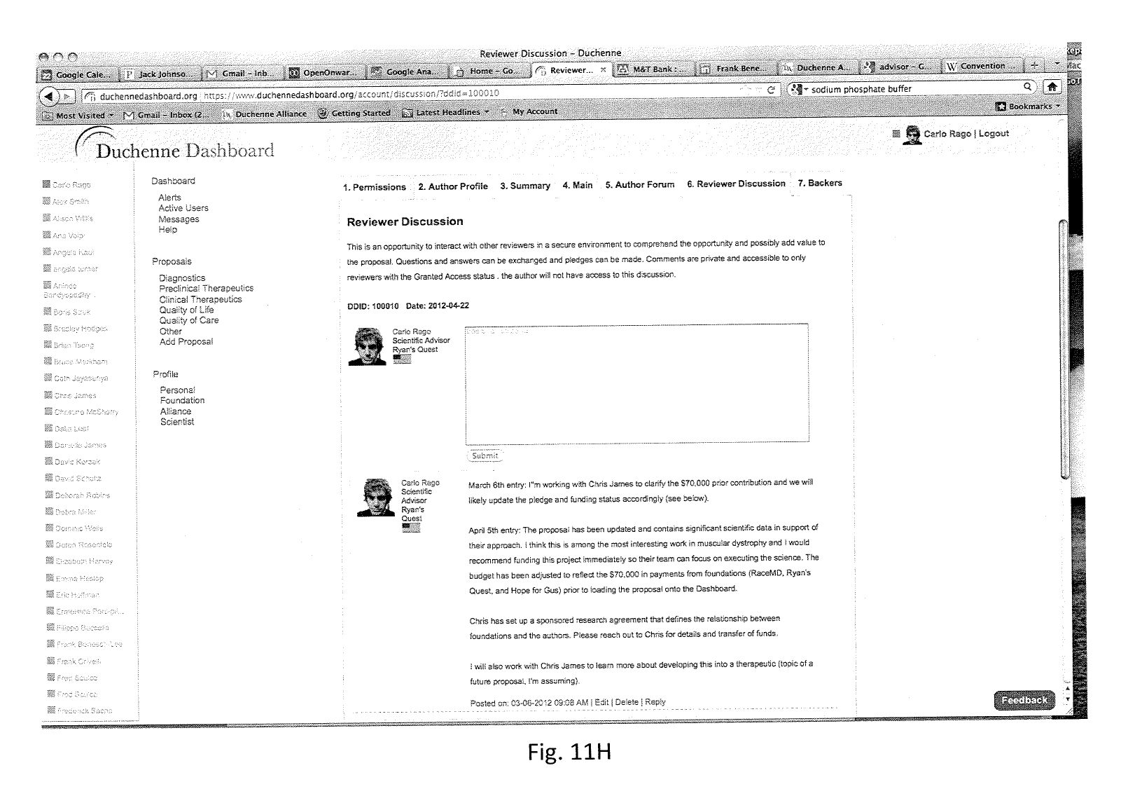

FIGS. 11A-11H illustrate example screen shots of a proposal space in accordance with aspects of the present invention.

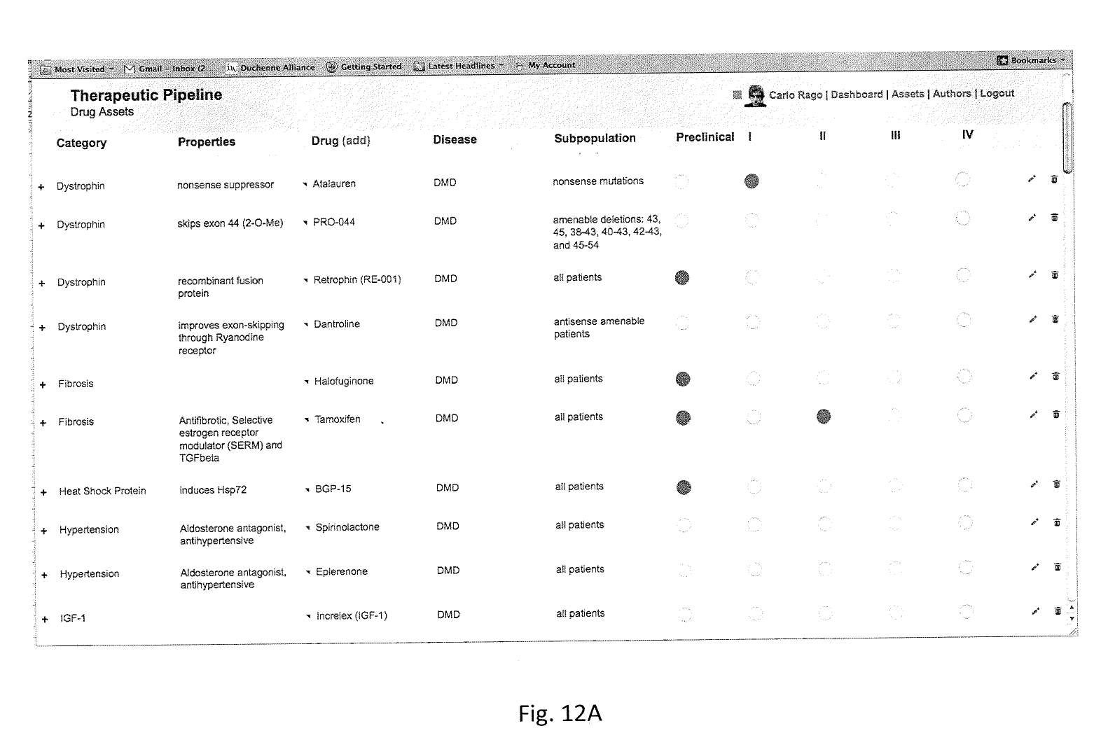

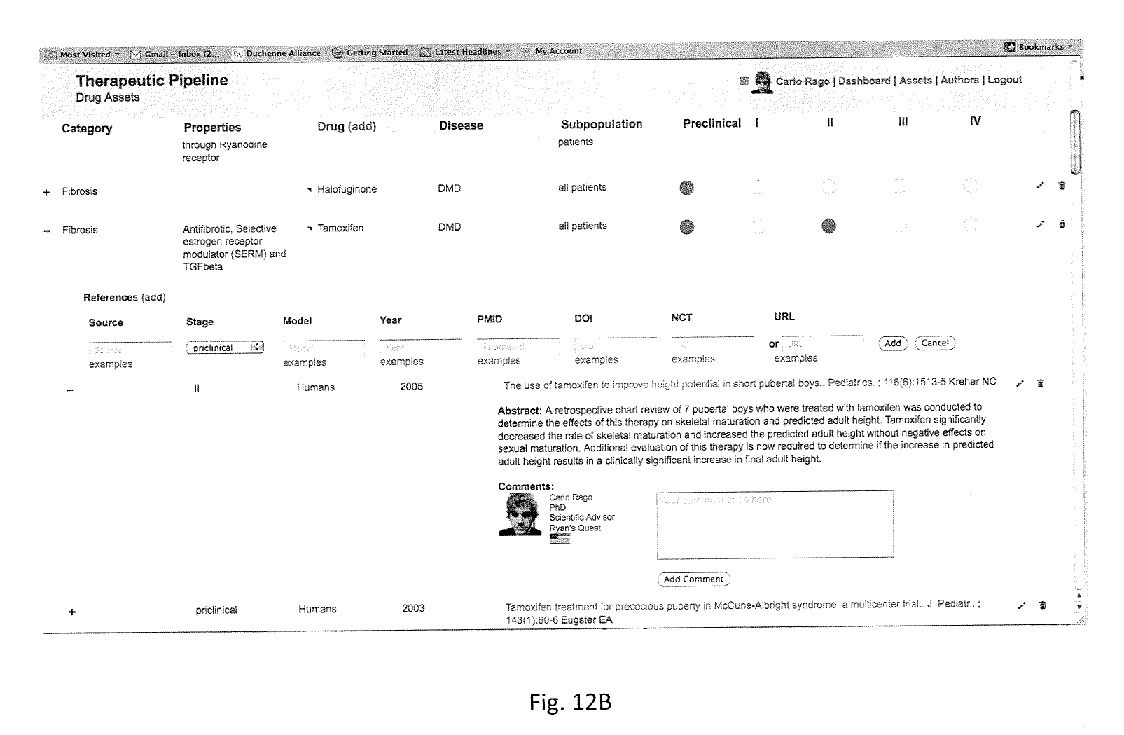

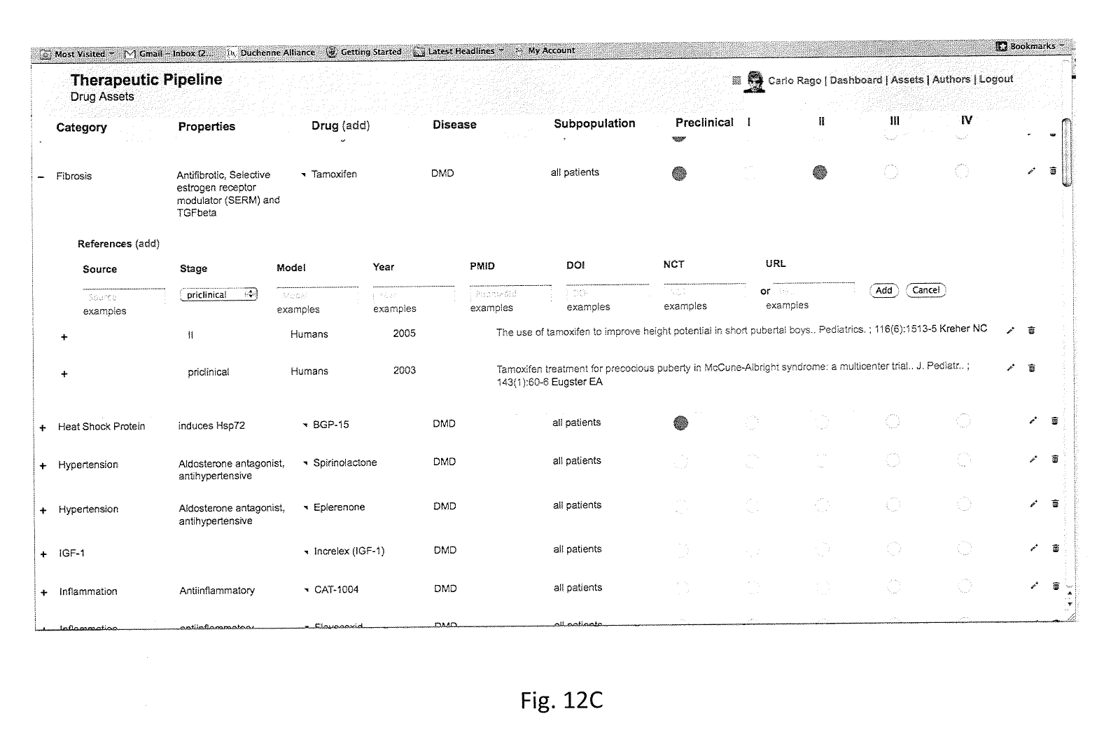

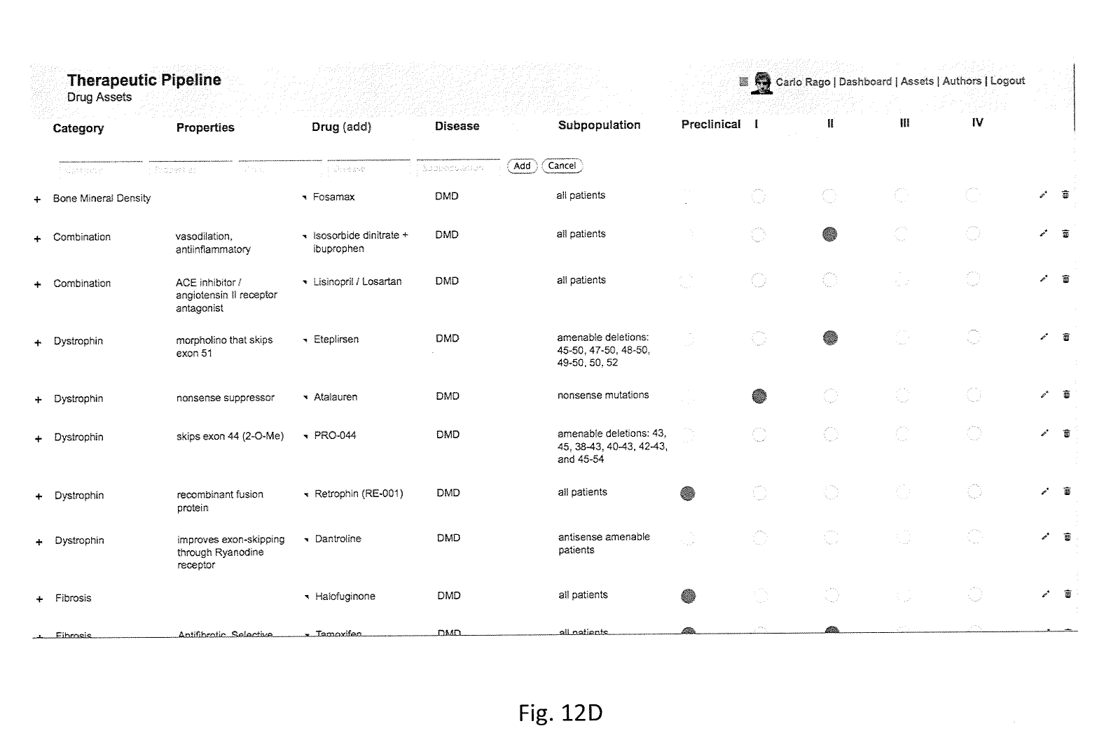

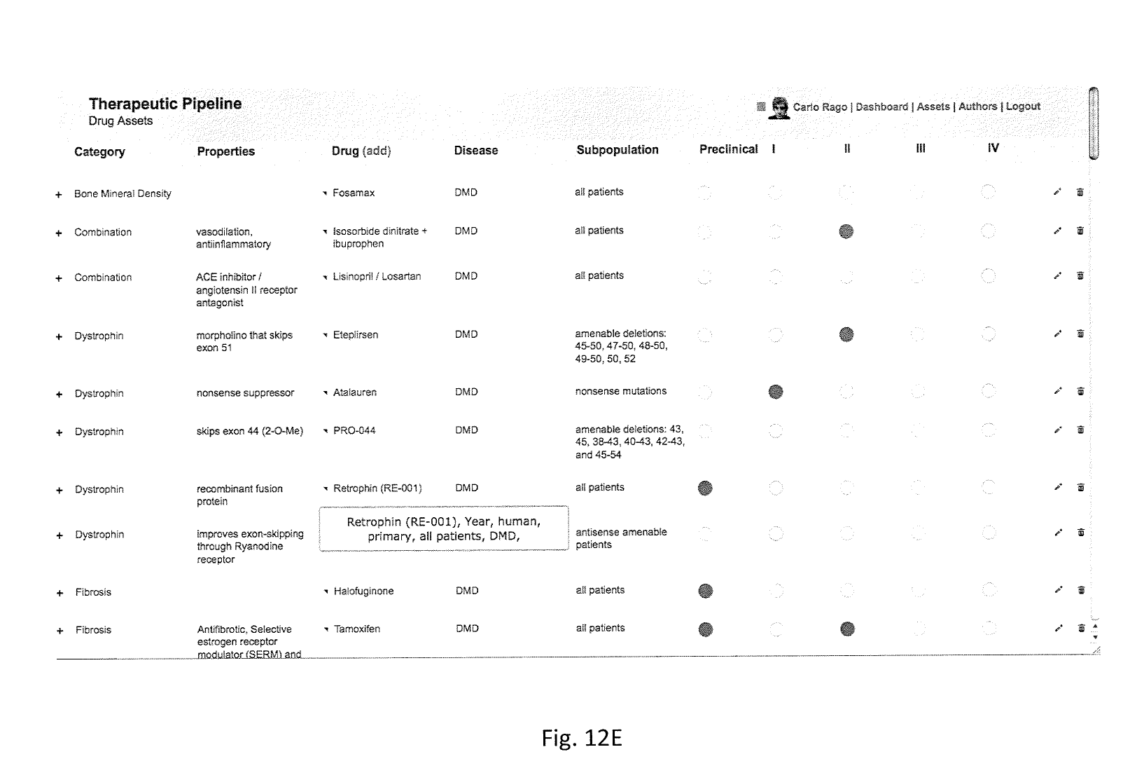

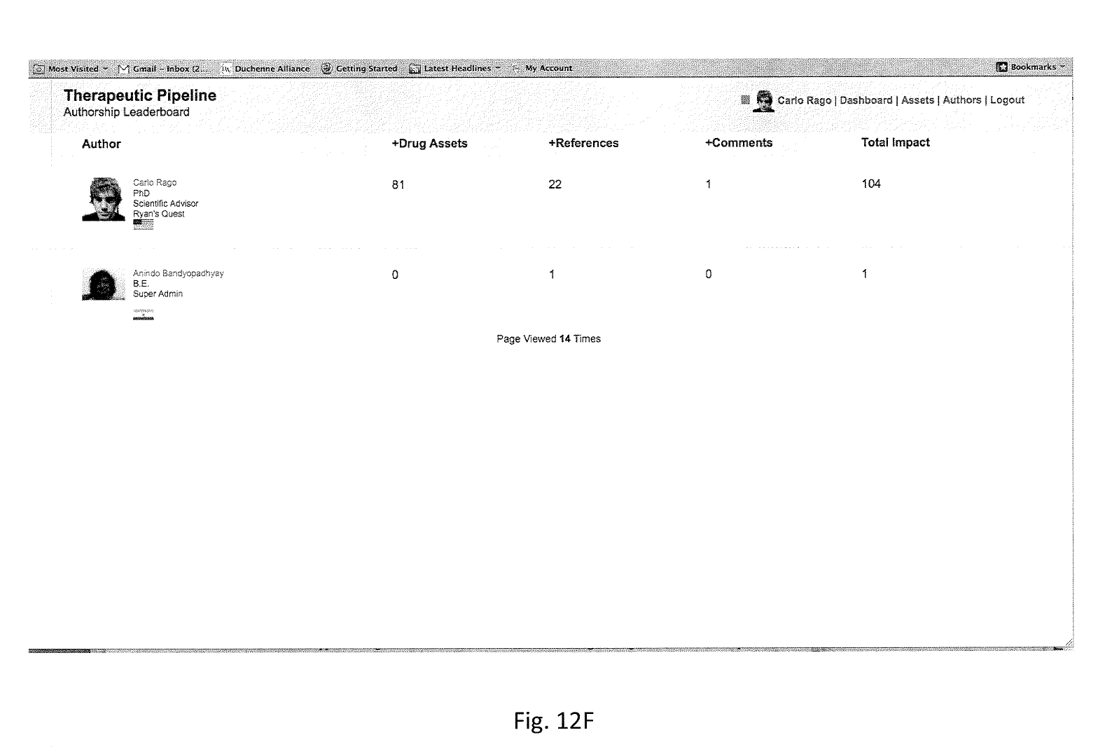

FIGS. 12A-12F illustrate example screen shots of a wiki module in accordance with aspects of the present invention.

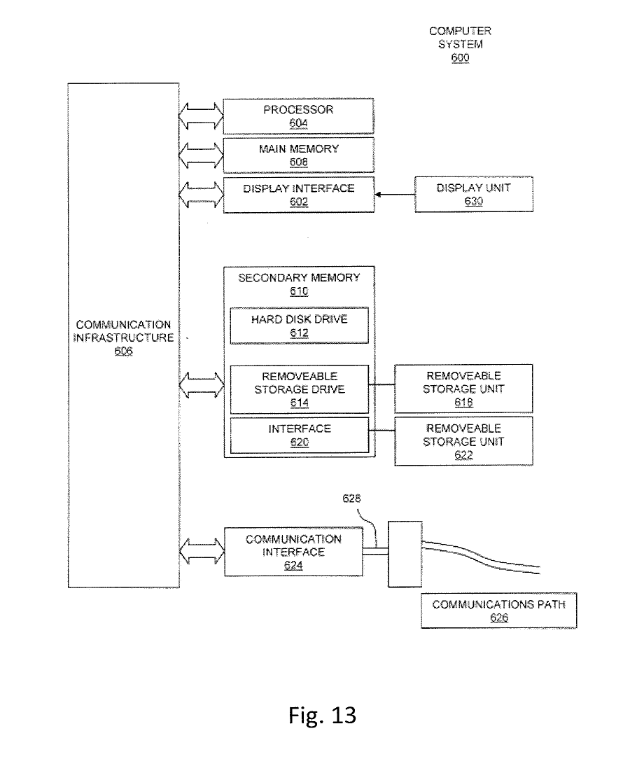

Aspects of the present invention, as well as programming functions performed via a separate terminal, may be implemented using a combination of hardware, software and firmware in a computer system. In an aspect of the present invention, the invention is directed toward one or more computer systems capable of carrying out the functionality described herein. An example of such a computer system 600 is shown in FIG. 13.

Computer system 600 includes one or more processors, such as processor 604. The processor 604 is connected to a communication infrastructure 606 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 600 can include a display interface 602 that forwards graphics, text, and other data from the communication infrastructure 606 (or from a frame buffer not shown) for display on a display unit 630. Computer system 600 also includes a main memory 608, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, etc. The removable storage drive 614 reads from and/or writes to a removable storage unit 618 in a well-known manner. Removable storage unit 618, represents a floppy disk, magnetic tape, optical disk, etc., which is read by and written to removable storage drive 614. As will be appreciated, the removable storage unit 618 includes a computer usable storage medium having stored therein computer software and/or data.

Alternative aspects of the present invention may include a secondary memory 610 and may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628, which may be electronic, electromagnetic, optical or other signals capable of being received by communications interface 624. These signals 628 are provided to communications interface 624 via a communications path (e.g., channel) 626. This path 626 carries signals 628 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 614, a hard disk installed in hard disk drive 612, main memory 608, secondary memory 610, and signals 628. These computer program products provide software to the computer system 600. The invention is directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features of the present invention, as discussed herein. In particular, the computer programs, when executed, enable the processor 610 to perform the features of the present invention. Accordingly, such computer programs represent controllers of the computer system 600.

In an aspect of the present invention where the invention is implemented using software, the software may be stored in a computer program product and loaded into computer system 600 using removable storage drive 614, hard drive 612, or communications interface 624. The control logic (software), when executed by the processor 604, causes the processor 604 to perform the functions of the invention as described herein. In another aspect of the present invention, the invention is implemented primarily in hardware using, for example, hardware components, such as application specific integrated circuits (ASICs). Implementation of the hardware state machine so as to perform the functions described herein will be apparent to persons skilled in the relevant art(s).

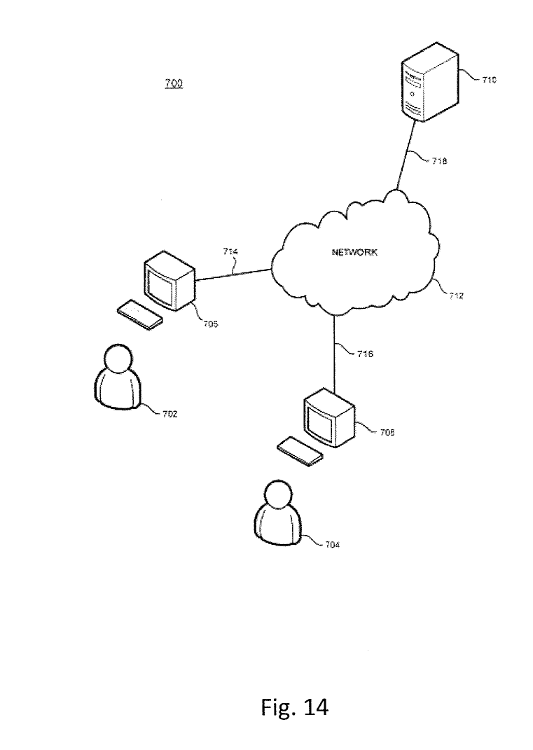

FIG. 14 shows a communication system 700 usable in accordance with aspects of the present invention. The communication system 700 includes one or more accessors 702, 704 (also referred to interchangeably herein as one or more “users” or “members”) and one or more terminals 706, 708. According to one aspect, data for use in accordance with the present invention is, for example, input and/or accessed by accessors 702, 704 via terminals 706, 708, such as personal computers (PCs), minicomputers, mainframe computers, microcomputers, telephonic devices, or wireless devices, such as personal digital assistants (“PDAs”) or a hand-held wireless devices coupled to a server 710, such as a PC, minicomputer, mainframe computer, microcomputer, or other device having a processor and a repository for data and/or connection to a repository for data, via, for example, a network 712, such as the Internet or an intranet, and couplings 714, 716, 718. The couplings 714, 716, 718 include, for example, wired, wireless, or fiberoptic links. According to another aspect, the method and system of the present invention may operate in a stand-alone environment, such as on a single terminal.

While the foregoing disclosure discusses illustrative aspects and/or embodiments, it should be noted that various changes and modifications could be made herein without departing from the scope of the described aspects and/or embodiments. Other aspects will be apparent to those skilled in the art from a consideration of the specification or from a practice of the invention disclosed herein. Furthermore, although elements of the described aspects and/or embodiments may be described in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for federating grant funding and proposal publication in a web-based environment, comprising:
receiving an electronic submission of at least one grant proposal;
determining whether to publish at least a portion of the grant proposal to a publicly-accessible space based on a plurality of indicators; and
publishing at least the portion of the grant proposal to the publicly-accessible space if a first indicator and a second indicator of the plurality of indicators are in an authorized publication state.

2. The method of claim 1, wherein the authorized publication state of the first indicator corresponds to an electronic indication by an author of the at least one grant proposal to authorize publication of the at least one grant proposal.

3. The method of claim 1, wherein the authorized publication state of the second indicator corresponds to an electronic indication by a reviewer of the at least one grant proposal to authorize publication of the at least one grant proposal.

4. The method of claim 1, wherein the plurality of indicators comprises a third indicator, where an authorized publication state of the third indicator corresponds to an electronic monetary pledge amount for the at least one grant proposal exceeding a threshold.

5. The method of claim 1, further comprising tracking a public pledge amount from the publicly-accessible space for the published portion of the grant proposal.

6. The method of claim 5, further comprising tracking a private pledge amount from a confidential space for the grant proposal.

7. The method of claim 6, further comprising displaying the public pledge amount and the private pledge amount on the publicly-accessible space.

8. The method of claim 1, further comprising:
measuring statistical information based on parameters associated with the at least one grant proposal, the parameters including a private pledge amount and a funding amount of the at least one grant proposal; and
generating reports based on the measured statistical information.

9. The method of claim 8, further comprising:
receiving at least one input of a value related to an assessment of a quality of the at least one grant proposal; and
rating the at least one proposal with a score based on the value or an aggregate of a plurality of values if more than one input has been received, wherein the score indicates a worth of the at least one grant proposal.

10. The method of claim 8, further comprising:
receiving a plurality of inputs related to an at least one of a quantitative, a qualitative, a subjective, and an objective assessment of a quality of the at least one grant proposal; and
rating the at least one proposal with a score based on an aggregate of the plurality of inputs, wherein the score indicates a worth of the at least one grant proposal.

11. The method of claim 8, further comprising:
receiving a plurality of inputs related to an at least one of a quantitative, a qualitative, a subjective, and an objective assessment of a quality of the at least one grant proposal; and
storing the plurality of inputs for valuation of the at least one grant proposal by a third party.

12. An apparatus, comprising:
a proposal module configured to receive an electronic submission of at least one grant proposal;
a public module configured to:
determine whether to publish at least a portion of the grant proposal to a publicly-accessible space based on a plurality of indicators; and
publish at least the portion of the grant proposal to the publicly-accessible space if a first indicator and a second indicator of the plurality of indicators are in an authorized publication state.

13. A system, comprising:
means for receiving an electronic submission of at least one grant proposal;
means for determining whether to publish at least a portion of the grant proposal to a publicly-accessible space based on a plurality of indicators; and
means for publishing at least the portion of the grant proposal to the publicly-accessible space if a first indicator and a second indicator of the plurality of indicators are in an authorized publication state.

14. A computer program product comprising a non-transitory computer-readable medium having control logic stored therein for causing a computer to perform proposal publication, comprising:
code for receiving an electronic submission of at least one grant proposal;
code for determining whether to publish at least a portion of the grant proposal to a publicly-accessible space based on a plurality of indicators; and
code for publishing at least the portion of the grant proposal to the publicly-accessible space if a first indicator and a second indicator of the plurality of indicators are in an authorized publication state.

15. A method for displaying therapeutic information in a web-based environment, comprising:
receiving a content entry in a content space;
receiving a reference link associated with the content entry in the content space, the reference link configured to link out to a third party website with affiliation to the content entry; and
generating in the content space a content entry listing having embedded therein the reference link that is configured to link out to the third party website.

16. The method of claim 15, wherein the content entry comprises therapeutic information or reference related to a pharmaceutical drug.

17. The method of claim 16, further comprising:
displaying a plurality of fields representing stages related to development of the pharmaceutical drug;
indicating on the plurality of fields a progress associated with the development of the pharmaceutical drug.

18. The method of claim 16, further comprising:
receiving an input of a first rating score from a user, the first rating score relating to at least a portion of the therapeutic information comprising data, figures, and tables associated with the therapeutic information;
associating the first rating score with at least the portion of the therapeutic information;
receiving an input of a first text comment from a user, the first text comment relating to at least a portion of the therapeutic information comprising data, figures, and tables associated with the therapeutic information;
associating the first text comment with at least the portion of the therapeutic information;
receiving an input of a first tag from a user, the first tag relating to at least a portion of the therapeutic information comprising data, figures, and tables associated with the therapeutic information;
associating the first tag with at least the portion of the therapeutic information;
receiving an input of a first flag from a user, the first flag relating to at least a portion of the therapeutic information comprising data, figures, and tables associated with the therapeutic information; and
associating the first flag with at least the portion of the therapeutic information.

19. The method of claim 18, further comprising:
receiving an input of a second rating score from a user, the second rating score relating to the first text comment;
associating the second rating score with the first text comment;
receiving an input of a second text comment from a user, the second text comment relating to the first text comment;
associating the second text comment with the first text comment;
receiving an input of a second tag from a user, the second tag relating to the first text comment;
associating the second tag with the first text comment;
receiving an input of a second flag from a user, the second flag relating to the first text comment; and
associating the second flag with the first text comment.

20. The method of claim 19, further comprising:
storing a plurality of rating scores, text comments, tags, and flags in a first database in a memory.

21. The method of claim 20, further comprising:
receiving a search query from a user;
filtering the first database based on the search query; and
displaying a result of the filtering to the user.

22. The method of claim 20, further comprising:
receiving a sort input from a user;
sorting the first database based on the sort input; and
displaying a result of the sorting to the user.

23. The method of claim 2, further comprising:
displaying all or a portion of the therapeutic information in one or more web portals.

24. An apparatus, comprising:
a wiki module configured to:
receive a content entry in a content space;
receive a reference link associated with the content entry in the content space, the reference link configured to link out to a third party website with affiliation to the content entry; and
generate in the content space a content entry listing having embedded therein the reference link that is configured to link out to the third party website.

25. A system, comprising:
means for receiving a content entry in a content space;
means for receiving a reference link associated with the content entry in the content space, the reference link configured to link out to a third party website with affiliation to the content entry; and
means for generating in the content space a content entry listing having embedded therein the reference link that is configured to link out to the third party website.

26. A computer program product comprising a non-transitory computer-readable medium having control logic stored therein for causing a computer to perform linking, comprising:
code for receiving a content entry in a content space;
code for receiving a reference link associated with the content entry in the content space, the reference link configured to link out to a third party website with affiliation to the content entry; and
code for generating in the content space a content entry listing having embedded therein the reference link that is configured to link out to the third party website.
